(19) United States
(12) Patent Application Publication
(10) Pub. No.: US 2016/0042460 A1
(43) Pub. Date: Feb. 11, 2016

(54) SYSTEMS AND METHODS FOR MANAGING INTELLECTUAL PROPERTY ASSETS

(71) Applicant: Hudak Consulting Group, LLC, Sunnyvale, CA (US)

(72) Inventors: Jessica A. Hudak, Sunnyvale, CA (US); Ashley R. Sloat, Traverse City, MI (US); Kristen L. Wolff, San Mateo, CA (US)

(21) Appl. No.: 14/823,432

(22) Filed: Aug. 11, 2015

Related U.S. Application Data
(60) Provisional application No. 62/035,505, filed on Aug. 11, 2014.
(60) Provisional application No. 62/072,428, filed on Oct. 30, 2014.
(60) Provisional application No. 62/147,398, filed on Apr. 14, 2015.

(51) Int. Cl. G06Q 40/06

(52) U.S. Cl. CPC G06Q 40/06; G06Q 50/184

(57) ABSTRACT

Systems and methods for managing an intellectual property asset (IPA) are described herein. The system may include a first user interface on a computing device with software configured for receiving a first notification regarding an IPA. Further, the system may include at least one database, which includes information related to the IPA. The system may further include a second user interface on the computing device. The second user interface may be configured to display information related to the IPA and/or options for responding to the first notification. In some embodiments, the information and/or options may be retrieved from at least one database. A method for managing an IPA may include receiving a first notification in reference to an IPA, retrieving information related to the IPA, and displaying at least one option for responding to the first notification.

### CROSS-REFERENCE TO RELATED APPLICATIONS

This application claims priority under 35 U.S.C. §119(e) to U.S. Provisional Application Nos. 62/035,505 filed Aug. 11, 2014, 62/072,428 filed Oct. 30, 2014, and 62/147,398 filed Apr. 14, 2015, each entitled “Systems and Methods for Managing Intellectual Property Assets,” and each of which is herein incorporated by reference in its entirety.

### TECHNICAL FIELD

This disclosure relates generally to the field of asset and portfolio management, and more specifically, to new and useful systems and methods for managing intellectual property assets.

### BACKGROUND

Acquiring, managing, and maintaining intellectual property assets (IPAs) is critical for protecting original technologies, insignia, and content. Typically, navigating the complex pathways and systems of the governing bodies that review and grant protection for IPAs can be difficult and time-consuming.

As IPA portfolios grow for an individual inventor or company, it may become increasingly difficult for the inventor or company to recall or remember all the previous actions pertaining to a particular IPA, all relevant IPAs already present in the portfolio, and all possible actions and/or outcomes possible for the IPA. Further, budgetary concerns and tracking annuities add increased complexity to the process, requiring additional personnel and increased time commitment.

Thus, there is a need for new and useful systems and methods for managing intellectual property assets.

### SUMMARY

The present disclosure provides new and useful systems and methods for managing intellectual property assets. Various embodiments provided herein overcome one or more of the shortcomings of current intellectual property asset management systems and methods.

Aspects of the disclosure are directed towards systems and methods of managing an intellectual property portfolio. In various embodiments, the systems and methods automate document and data retrieval process from a plurality of databases, utilize electronic optical character recognition to scrape important data from retrieved documents, process and synthesize retrieved data, and layer the retrieved data with customized information to generate meaningful reports and insights. In some embodiments, the systems and methods provided herein may be used to create technology taxonomies, family trees, patent portfolio statistics, other reports, patent application templates, Office Action response templates, Information Disclosure Statements, and invention disclosure forms. In some embodiments, the systems and methods provided herein may be used to oversee the lifecycle of an intellectual property asset and coordinate the management of the intellectual property asset across a plurality of users.

One aspect of the disclosure is directed to a method of generating an intellectual property portfolio budget. The method of various embodiments is performed by an IP management computing device. The method includes: receiving a budget request for a future budgetary timeframe from a user via an input device; automatically identifying a status of each intellectual property asset within an intellectual property portfolio; automatically determining actions expected within the budgetary timeframe based on the status of each intellectual property asset; automatically retrieving invoice data for tasks performed within a past budgetary timeframe; automatically determining expected costs for each expected action and each expected new application based on the invoice data; and automatically generating an estimated budget, which includes the expected costs for the future budgetary timeframe. In some embodiments, the method further includes: receiving an estimate of expected new applications to be drafted and filed in the future budgetary timeframe from a user via an input device; automatically determining expected costs for each expected new application based on the invoice data; and adding the expected costs for each expected new application into the estimated budget.

In some embodiments, identifying a status of each intellectual property asset within an intellectual property portfolio includes accessing status data from an internal database. Such status data may be scraped by the IP management computing device from a patent office database. The status may include at least one of a basic prosecution classification, a prosecution history, an assigned examiner, an assigned art unit, and a filing date.

In some embodiments, determining actions expected within the budgetary timeframe includes: accessing historical patent office data, calculating average performance metrics from the historical patent office data, and predicting when actions are to be expected for each intellectual property asset based on the average performance metrics and the status of each intellectual property asset.

In some embodiments, the invoice data is retrieved from an internal database. The invoice data in the internal database may be pulled from an invoice that has been uploaded or imported into the IP management computing device.

In some embodiments, the estimated budget is output by the IP management computing system in a web-based editable format. In some embodiments, the method additionally includes receiving scenario modifications from a user, wherein the scenario modifications cause the IP management computing device to modify underlying parameters and generate a revised estimated budget.

Another aspect of the disclosure is directed to a system for generating an intellectual property portfolio budget. The system of various embodiments includes a computing device formed, at least in part, of a processor and a non-transitory computer-readable medium having instructions stored thereon. The instructions, when executed by the processor, cause the computing device to perform a method, such as, for example, the method described above. For example, in some embodiments, the computing device performs a method that includes: receiving a budget request for a future budgetary timeframe from a user via an input device; receiving an estimate of expected new applications in the future budgetary timeframe from a user via an input device; automatically identifying a status of each intellectual property asset within an intellectual property portfolio; automatically determining actions expected within the budgetary timeframe based on the status of each intellectual property asset; automatically retrieving invoice data for tasks performed within a past budgetary timeframe; automatically determining expected costs for each expected action and each expected new application based on the invoice data; and automatically generating an estimated budget comprising the expected costs for the future budgetary timeframe.

A further aspect of the disclosure is directed to a system for generating an intellectual property budget. The system of various embodiments includes a receiver for receiving from a user computing device: a budget request for a future budgetary timeframe, an estimate of expected new applications to be filed in the future budgetary timeframe, and an invoice for a past budgetary timeframe. In some embodiments, the receiver is further configured to pull a prosecution status for each intellectual property asset from a remote database. The system additionally includes a transmitter for transmitting to the user computing device an estimated budget containing costs expected in the future budgetary timeframe. A memory for storing invoice data for tasks performed within the past budgetary timeframe is also provided within the system. In various embodiments, the system further includes a processor configured to: extract the invoice data from the invoice, identify a status of existing intellectual property assets, determine actions expected within the future budgetary timeframe based on the status of each existing intellectual property asset, determine the expected costs for each expected action and each expected new application based on the invoice data, and generate the estimated budget.

### BRIEF DESCRIPTION OF THE DRAWINGS

FIG. 1 illustrates a schematic block diagram of one embodiment of a system for managing an intellectual property asset, in accordance with a preferred embodiment;

FIG. 2 illustrates a schematic block diagram of a system for managing an intellectual property asset, in accordance with an alternative preferred embodiment;

FIGS. 3A and 3B illustrate schematic drawings of a client and administration dashboard interface, respectively, in accordance with a preferred embodiment;

FIG. 4 illustrates a schematic drawing of an invention disclosure interface, in accordance with a preferred embodiment;

FIG. 5 illustrates a schematic drawing of a meeting interface, in accordance with a preferred embodiment;

FIG. 6 illustrates a schematic drawing of an IPA specific interface, in accordance with a preferred embodiment;

FIG. 7 illustrates a schematic drawing of a prosecution history interface, in accordance with a preferred embodiment;

FIG. 8 illustrates a schematic drawing of a pending claims interface, in accordance with a preferred embodiment;

FIG. 9 illustrates a schematic drawing of a rejections interface, in accordance with a preferred embodiment;

FIG. 10 illustrates a schematic drawing of a signatures interface, in accordance with a preferred embodiment;

FIG. 11 illustrates a schematic drawing of a family interface, in accordance with a preferred embodiment;

FIG. 12 illustrates a schematic drawing of a bibliographic data interface, in accordance with a preferred embodiment;

FIG. 13 illustrates a schematic drawing of a related claims interface, in accordance with a preferred embodiment;

FIG. 14 illustrates a schematic drawing of a response options interface, in accordance with a preferred embodiment;

FIG. 15 illustrates a schematic drawing of a technology categorization interface, in accordance with a preferred embodiment;

FIG. 16 illustrates a schematic drawing of a docketing interface, in accordance with a preferred embodiment;

FIG. 17 illustrates a schematic drawing of an email interface, in accordance with a preferred embodiment;

FIG. 18 illustrates a schematic drawing of an account settings interface, in accordance with a preferred embodiment;

FIG. 19 illustrates a flow chart of a method for managing an intellectual property asset, in accordance with a preferred embodiment;

FIG. 20 illustrates a flow chart of a method for managing an intellectual property portfolio, in accordance with a preferred embodiment;

FIG. 21 illustrates a schematic block diagram of one embodiment of a system for managing an intellectual property asset, in accordance with a preferred embodiment; and

FIG. 22 illustrates a functional block diagram of one embodiment of a system for managing an intellectual property asset, in accordance with a preferred embodiment.

### DETAILED DESCRIPTION

The following description of the preferred embodiments is not intended to limit the invention to these preferred embodiments, but rather to enable any person skilled in the art to make and use this invention. Disclosed herein are systems and methods for managing intellectual property assets (IPAs).

In general, described herein are systems and methods for managing IPAs. An IPA may include an invention disclosure, patent application, issued patent, trademark application, issued trademark, copyright application, granted copyright, trade secret, and/or any other type of IPA an inventor, individual, company, applicant, or group is seeking to protect and/or manage. The systems and methods of the present disclosure may function to update databases, inform decisions on IPAs, review past and present information and/or action items, send instructions, inform budgets, verify annuity invoices, create presentations, manage scheduling, manage meetings, revise documents, and/or any other task associated with an IPA.

The systems and methods of the present disclosure may be used and/or performed by an individual or inventor acting in a pro se capacity, an individual or inventor working with a law firm, individuals within a company, applicant(s), in-house counsel in a company, a consulting group, a consultant, a patent agent, an attorney, a law firm, an annuity service, or any other individual, company, or group seeking to protect and/or manage IPAs, collectively referred to as “a user” or “users”. The system may function as an interface between two or more users, for example, an individual, inventor, or consultant and a law firm.

The systems and methods described herein may use, collect, or otherwise gather information from collections of information, referred to herein as “databases”. Thus, the systems and methods described herein may be designed to accommodate and interface with a variety of databases, for example, the systems and methods may include open database architecture. The databases may be publicly available or require a password, license, and/or payment to access the database. The databases may include docket and bibliographic information databases, intellectual property office databases, for example, those from the United States Patent and Trademark Office (USPTO), the European Patent Office, the Japanese Patent Office, etc., taxonomy databases, categorization databases, publication databases, annuity service databases, fee schedule databases, and/or any other type of information resource available publicly, selectively, or privately.

The systems and methods described herein may be configured to be user-specific and/or permissions regulated. Security partitioning, permissions, authority, and/or read-only configurations may regulate, control, and/or otherwise limit a user's interaction with the systems. In some embodiments, Internet security procedures may be employed when users outside the firewall design security layers for use, for example, when software communicates with online portals.

In general, permissions may be limited to various portions of the system and/or various functions within the system. For example, a first user may only have access to the administrative portal or a user may only have access to submit invention disclosure statements. In some embodiments, a user may submit invention disclosures without logging into the system. For example, the system may simply verify that the portal was accessed from a link sent to a company email address or may otherwise authenticate/verify the user by their company email address or other user identifier (e.g. name, address, security question answer, etc.).

The system may include multiple user interfaces. Each of the multiple user interfaces may provide a unique level of control or access or a unique user experience or set of information to a user. Each user interface may include controls, which enable a user to interact with the user interface. The user interface may include buttons, sliders, toggle buttons, toggle switches, switches, dropdown menus, combo boxes, text input fields, check boxes, radio buttons, picker controls, segmented controls, steppers, and/or any other type of control. In some embodiments, a user interface may be configured for read-only use or user interaction. In some embodiments, the user interactions enabled by the user interface may include editing, amending, discarding or deleting, chatting, messaging, emailing, selecting and/or choosing controls, saving, generating reports, and/or any other type of user interaction. In some embodiments, a user interface may extend beyond the view of a user. Slider controls and/or touchscreen enabled movements (e.g., finger swipes) may be used to navigate around a user interface to see all portions of the user interface.

In some embodiments, each IPA within the portfolio has its own interface. The interface may include the current status of the IPA, action required if any, deadline if any, expected time until next action, bibliographic information, or any other important quick reference information. A user is able to click through to see prosecution history, current claims, family members, and other IPAs in the same technology category. If there is an action required on that IPA, the user may be able to click through to see a presentation of the current rejection(s) and any useful information to make a decision about that action.

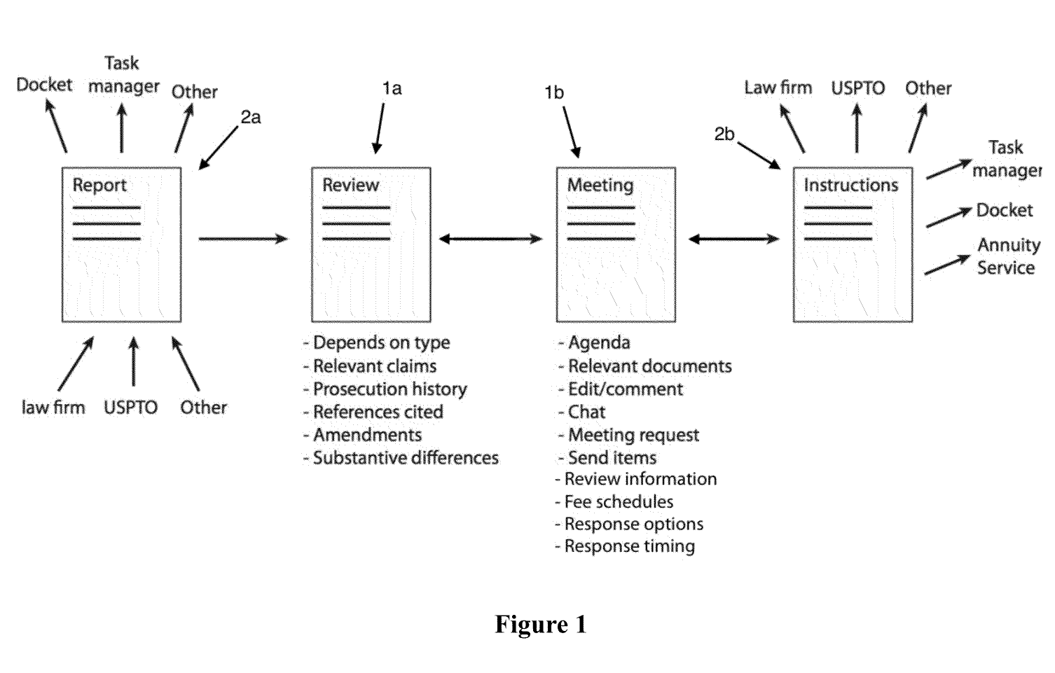

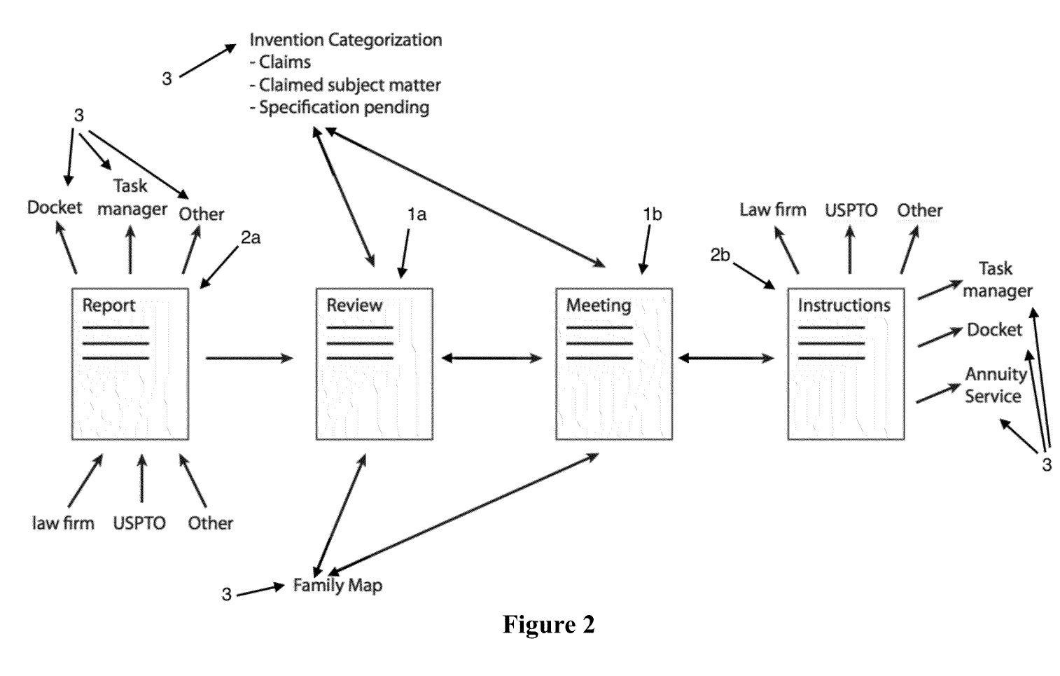

FIGS. 1 and 2 illustrate two embodiments of a system for managing an intellectual property asset (IPA). As shown in FIGS. 1 and 2, a system for managing an IPA may include a first “review” user interface 1a on a computing device configured with software stored on a non-transitory computer readable medium and executable by the computing device. The first user interface 1a may be configured for receiving a first notification 2a regarding an IPA. The system may further include at least one database, which includes information related to the IPA. The at least one database may be stored on the computing device or be accessible via the computing device. For example, the at least one database may be stored on a remote server and accessible to the computing device via a network connection.

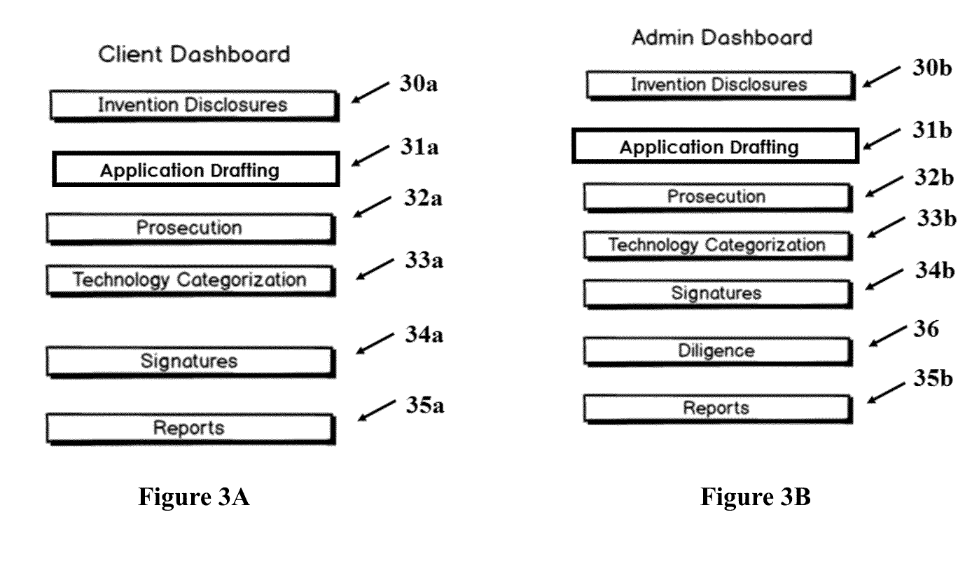

The system, as shown in FIG. 1, may further include a second “meeting” user interface 1b on the computing device. The second user interface 1b may be configured to display information related to the IPA and/or options for responding to the first notification. As shown in FIG. 1, the information and/or options may be retrieved from at least one database. In some embodiments, the first and second user interfaces 1a/1b may be on the same computing device, for example, two different screens or pages within the same application. Alternatively or additionally, the first and second user interfaces 1a/1b may be on the same computing device, but two different screens or pages within two different applications. Alternatively or additionally, the first and second user interfaces 1a/1b may be on a first and second computing device, respectively. In some embodiments, information related to an IPA (e.g., reviewing the IPA) on the first user interface may be presented across several different user interfaces, for example, as shown in FIGS. 3-18, such that a user can click through to the user interface of interest.

Now turning again to FIGS. 1 and 2, as show in FIGS. 1 and 2, a first notification 2a or “report” may be received by the system. The first notification 2a may be sent to the system by a law firm, the United States or a foreign intellectual property office, a consultant, an inventor, an individual, a company, and/or any other type of user, as described above. The first notification 2a may include docketing information, action items, deadline notices, categorization data, continuity data, informational notices, instructions, drafts, invoices, or any other type of information relevant for an IPA. The information enclosed in the first notification 2a may flow, be transferred, copied, or otherwise moved to a docket, task manager (e.g., meeting portal/interface), database, review document, annuity service, and/or any other type of user interface and/or database. In some embodiments, information in a first notification 2a, for example, an invoice, may be automatically verified with information in one or more databases to determine the accuracy of the invoice. The text, figures, language, and/or content of the first notification 2a may be computer readable and/or machine encoded, such that they are extractable and processable from their context. Conversely, the text, figures, language and/or content may not be originally machine encoded and/or computer readable, such that they are composited into an image-based context and require processing with an optical character recognition (OCR) pass.

As shown in FIG. 1, the information from the first notification 2a may be combined with information in a first user interface 1a or a “review” interface. As shown in FIG. 1, the first user interface 1a may be configured for receiving information and/or content from a first notification 2a regarding an IPA. The content and/or information in the first notification 2a may flow, be transferred, copied, or otherwise moved to the first user interface 1a, as shown in FIG. 1. Further, information from one or more databases 3 may flow, be transferred, copied, or otherwise moved to the first user interface 1a, as shown in FIG. 2. The first user interface 1a may include a review interface for reviewing an IPA, action item, concern, or other content associated with an IPA (e.g., family, categorization, prosecution history, etc.). The first user interface 1a structure and function may depend on the type of first notification 2a received and/or the information being presented, as will be described in further detail below. The first user interface 1a may include relevant claims, due dates, action information, prosecution history, references cited, proposed amendments, and/or substantive differences, as will be described in further detail below. Further the review information from the first user interface 1a may be transferred, moved, or otherwise copied to the second user interface 1b.

As shown in FIG. 1, the second user interface 1b may include a “meeting” interface, allowing the content in the second user interface 1b to be reviewed in a meeting and/or with one or more users. The second user interface 1b may include content and/or information from the first user interface 1a, such that the content and/or information from the first user interface 1a flows, is transferred to, is copied to, or otherwise mirrors content in the second user interface 1b. The second user interface 1b, as shown in FIG. 1, may include an agenda, relevant documents for review, and fee schedules, response options, and response timing and/or turn around time for domestic and foreign intellectual property offices, as will be described in further detail below. Further, the second user interface 1b may include edit, comment, chat, meeting request, and scheduling functionality as well as an email component for communicating with at least one user, as will be described in further detail below.

In some embodiments, as shown in FIG. 1, decisions, instructions, questions, and/or other communications may be sent in a second notification 2b to a user or database 3, as described above. In some embodiments, as shown in FIGS. 1 and 2, information may flow from the second notification 2b to the second user interface 1b, from the second user interface 1b to the first user interface 1a, and/or from the first notification 2a to the second user interface 1b.

In some embodiments, a user may be presented with a user interface in which the user may select a topic from a limited number of selections. The interface may be a clean, simple interface that is not intimidating and makes the system approachable. As shown in FIGS. 3A and 3B, the system may detect if the user is a client or administrator (referred herein as “admin”) and present the user with one of two interfaces. For example, a user that is a client may be presented with a “client dashboard” that includes buttons for submitting invention disclosures 30a, drafting patent applications 31a, reviewing and/or deciding on prosecution matters 32a, reviewing the technology categorization of an IPA 33a, signing required documents 34a, and reviewing and/or generating reports 35a, as shown in FIG. 3A. Alternatively, a user that is an admin may be presented with an “admin dashboard,” as shown in FIG. 3B, that includes buttons for reviewing invention disclosures 30b, drafting patent applications 31b, preparing and/or finalizing prosecution matters 32b, reviewing technology categorization and/or categorizing an IPA 33b, preparing and/or finalizing signature documents 34b, performing diligence 36, and reviewing and/or generating reports 35b. Each of these interfaces will be described in further detail below.

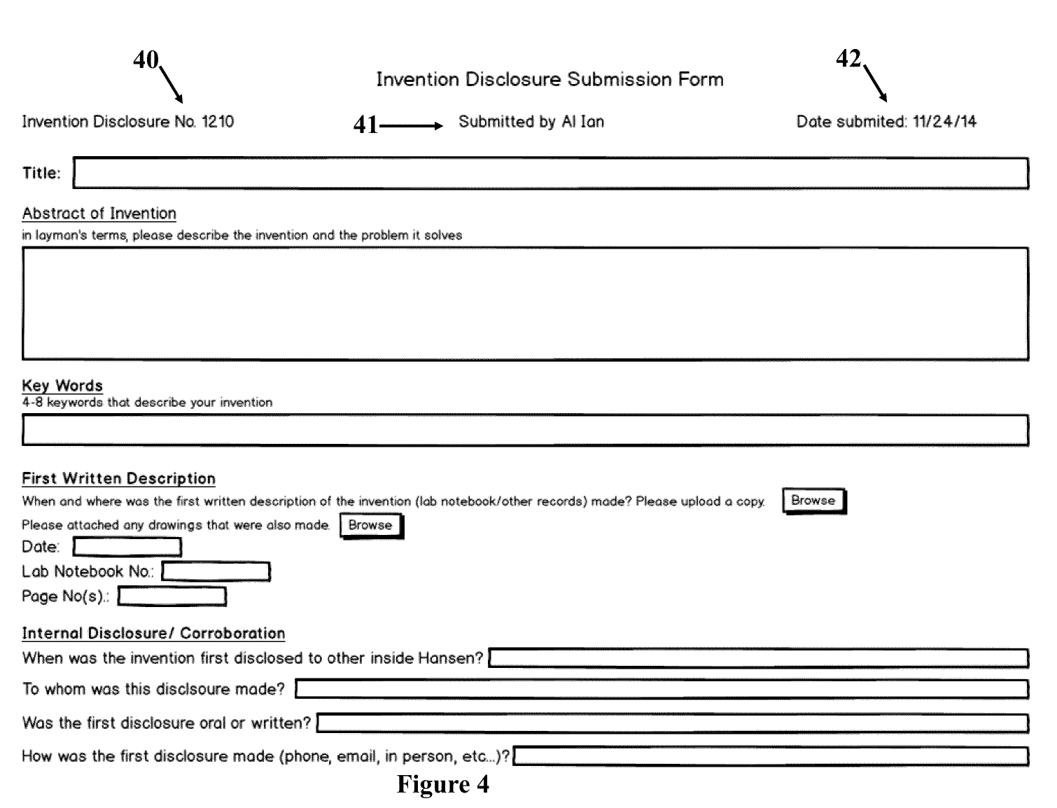

As shown in FIG. 4, the invention disclosure portal may include a fillable form through which an inventor may submit the details of an invention. In some embodiments, the invention disclosure form may include a single entry field or a limited number of entry fields, such that an invention may be evaluated by a committee before the inventor fills in the entire form. Additionally or alternatively, the invention disclosure form may include multiple fields in which an inventor may describe the invention before or after evaluation of the invention by a committee. The system may autogenerate an invention disclosure form (IDF) number 40, for example, in ascending order, such that each IDF may be identified. The system may recognize the user 41, such that the user's name is indicated on the IDF and linked to the IDF. Further, the system may date and time stamp the IDF 42. In some embodiments, the invention disclosure portal may include data entry fields such as title of the invention, abstract, key words, details about internal and external (e.g., public) disclosures of the invention, details about the reduction to practice, an invention description, variations/additional uses for the invention, related publications and/or commercial products, and/or any other information related to the invention. The form or document may be configured to accept, within one or more of its data entry fields, data of varying formats, including text, figures, source code, experimental data (e.g., charts or tables of data), or any other information. Alternatively, a user may be able to upload a completed IDF into the system (e.g., an IDF completed in a word processor or by hand). In some embodiments, the system may use OCR or other software/technologies to convert the IDF into an editable version. Additionally, the user may upload documents, figures, publications, etc. into the invention disclosure portal for consideration along with the IDF. In some embodiments, each open IDF may be listed in a separate user interface with a status identifier. For example, “submitted,” “patent committee,” “final decision,” “filed,” “on-hold,” or any other suitable status.

Multiple users may access the same IDF to edit and/or review it before submitting the IDF for approval. In some embodiments, the system may track or log the names, times, and/or dates of reviewing and/or editing. Once the form is submitted, there may be an optional review step where a manager or patent practitioner may be able to review and edit the IDF before it is submitted for review in a meeting and/or by a committee. The system may autogenerate and/or include a meeting interface for use during an invention disclosure review committee meeting. The system may present data about which claims are in the same family or technology category, competitive patents and/or products related to the invention, or any other suitable information that may be useful when deciding what to do (e.g., file, publish, keep as trade secret, do nothing) with the invention disclosure. The user may be able to send instructions to, or ask questions of, his/her attorney, practitioner, or colleagues. If the decision is made to file the application, a new IPA interface is created for that application.

In some embodiments, when a user wishes to draft a new application, the user may be able to select a new application option from the application drafting portal. Upon selection, the user may be prompted to enter a title and information about any related applications. Alternatively, in some embodiments, a user may be able to select an IDF from the list of IDFs existing within the Invention Disclosure portal, and the title and related application information is pulled automatically from the IDF. The user may draft claims directly within the application drafting portal or upload or import the claims into the application drafting portal. In some embodiments, the user may enter the claims as sentences into the application drafting portal, and the system automatically numbers the claims. The user may be provided with a drop-down menu or prompt for designating which claim, if any, a particular claim depends from. If a user indicates that a particular claim depends from another claim, the appropriate dependent claim language (e.g., “The system of claim 1”) may be added to the claim language by the system. In some embodiments, a user may be able to select two independent claims. In such instances, the draft claim is copied to appear under each respective independent claim. In some embodiments, claims may be moved around or added, and the claim numbering, including the numbering of dependent claims, will automatically update. In some embodiments, once the claims are drafted, the system automatically converts the text of the claims into paragraph form for use in the summary and/or detailed description of the specification. In some embodiments, the application drafting portal generates an application template with the title, reference to any related applications, and the claims included. In some embodiments, an Abstract and/or Background are also pulled and included into the application template, if provided in the linked IDF. Additionally or alternatively, the application template may include a pre-filled Summary section, which includes the claims written in paragraph form. In some embodiments, if edits are made to the claims, the user is asked if the user wishes to make the same edits to the Summary. In some embodiments, the Summary section is automatically updated to reflect changes to the claims. In some embodiments, the application template additionally or alternatively includes pre-set language used in each application template. This pre-set language may be preset by the system or pre-set by the user.

A user may additionally or alternatively be provided with tools within the application drafting portal for: viewing existing applications and patents in the portfolio, and copying relevant disclosure from the portfolio into the current application template. In some embodiments of the application drafting interface, a user is provided with an option to upload or import figures into the system. Once uploaded or imported, the system may automatically number the figures and/or provide tools for the user to number figures. In some embodiments, the user can get a dialogue box or window to appear, for example, by clicking, double clicking, or hovering over one of the uploaded figures. In the dialogue box, the user is prompted to enter a figure number, select a type of view (e.g., a perspective view, front plan view, schematic block diagram, flow chart, etc.), and provide a few word summary of what the figure shows. In such embodiments, the application drafting portal adds a Brief Description of the Drawings into the application template reflecting the information entered by the user in the various dialogue boxes or windows. In some embodiments, the application drafting portal also provides a user with an option to enter: each reference number shown in the figures, and the name of a respective element. In some such embodiments, any time the user types the name of the respective element within the body of the application, the system auto-inserts the reference number after the element name.

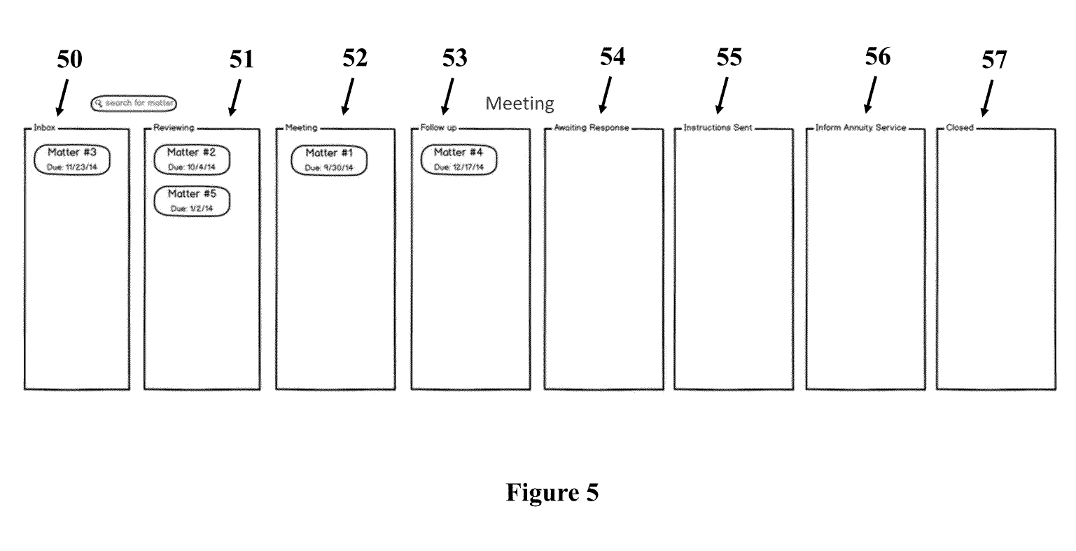

As shown in FIG. 5, the meeting portal may include several bins or columns in which prosecution matters may be deposited. Prosecution matters may include office actions, notice of allowances, conversion deadlines (e.g., provisional to Nonprovisional), foreign filing deadlines, application drafts, and/or general reminders (e.g., related to R&D, presentations, etc.). In the case of foreign filing decisions, the system may provide a reminder to the client as to the client's general strategy for foreign filing, for example, in which countries the client files commercial embodiments versus in which countries the client files defensive IP. Alternatively or additionally, information from diligence, new inventions, or any other suitable interface may be added to the meeting portal. A user may be able to click an “add to agenda” button at several points within the system to add a new action item or question to the agenda. The meeting portal may include a list of IPAs for which decisions need to be made, dates and/or deadlines for completion of tasks and/or action items for IPAs, notes and/or comments related to IPAs, and/or any other type of information. In some embodiments, the meeting portal may include access to relevant documents. The relevant documents may be stored and/or accessed locally or remotely from a database, server, and/or application. The relevant documents may be publications, references, notifications, notices, emails, and/or any other information relevant for making decisions related to an IPA. Within the meeting portal, the user may be presented with any deadlines approaching within a predetermined and/or configurable time frame. For example, the user may be presented with deadlines approaching in the next two weeks. From there, a user may be able to click through any of the IPAs with a deadline approaching and review necessary actions.

The bins or columns of the meeting portal may include an “inbox” column 50 for detailing newly received prosecution matters, for example, from a first notification; a “reviewing” column 51 including those prosecution matters being prepared and/or reviewed by admin; a “meeting” column 52 including actions that should be decided at an upcoming meeting; a “follow-up” column 53 including reminders for admin for additional tasks to be performed for a prosecution matter; an “awaiting response” column 54 for prosecution matters being reviewed by the client; an “instruction sent” column 55 for prosecution matters for which instructions have been sent to outside counsel; an “inform annuity service” column 56 for IPAs that should be added to an annuity payment schedule; “closed” column 57 for prosecution matters that are completed; and/or any additional column. In some embodiments, an “awaiting Office Action” column is provided to capture all filed IPAs that are awaiting an action by the relevant IP office (e.g., the US Patent and Trademark Office). From the meeting portal, a user may select any prosecution matter and access information about that matter, any action required, and/or decision options where applicable; the user may also be able to send instructions to or ask questions of their attorney, practitioner, or other colleagues. Additionally or alternatively, a user may use a search bar to search for a particular prosecution matter of interest. A user may be able to search by patent identification number, inventor, title, reference/docket or matter number, subject matter, family, technology categorization, or nickname. The nickname may be a shorthand reference to the application such as the relevant product, technology, subject matter, etc. If a user's search returns multiple entries, the system displays for each entry: the current status of the respective application; action required, if any; the deadline, if any; the expected time until next action; or any other important quick reference information. In some embodiments, prosecution matters may be moved manually (e.g., using drag and drop functionality, clicking a user interface control, etc.) between columns. Alternatively, the system may determine when a prosecution matter has reached a certain stage and automatically move the prosecution matter to the relevant column.

In some embodiments, the “meeting” column may be automatically populated by the system by collecting any “action required” matters that have a deadline within a specified timeframe. In some embodiments, the meeting portal may be accessible from the client/admin dashboard interface or may be navigated to from any other interface of the system.

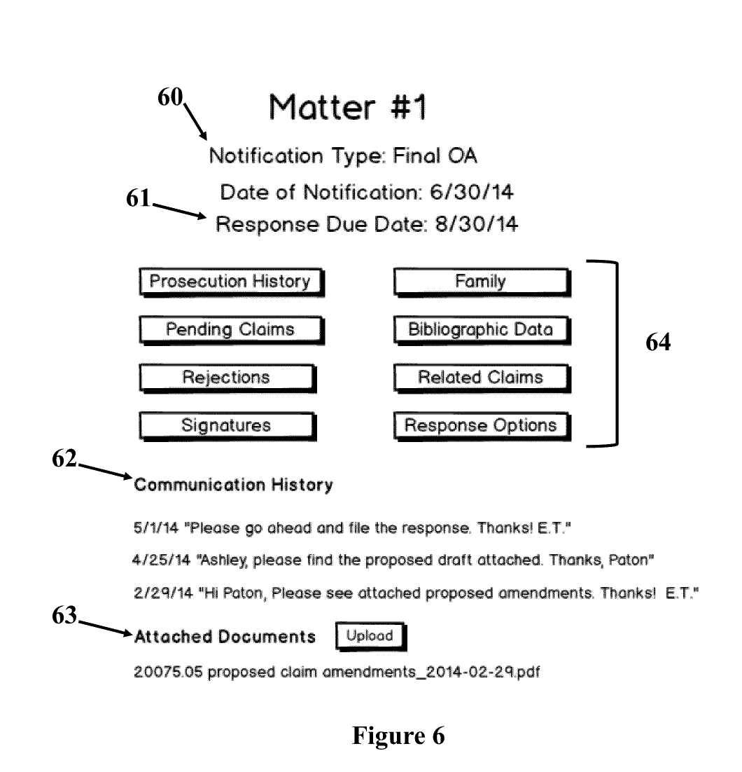

A user may navigate directly to a matter specific interface for an IPA, as shown in FIG. 6, by selecting the IPA during login or in the meeting portal, by searching for the IPA in a search bar, or from any other interface that lists the IPA. A matter specific interface, as shown in FIG. 6, may include information related to deadlines 61, types of notification(s) received related to the IPA (e.g., non-final office action) 60, a communication history 62, and/or documents related to the IPA 63. In some embodiments, the system may automatically receive deadline and/or first notification information related to an IPA from an email, a database (e.g., PAIR), or another relevant source. The communication history may be transferred manually (e.g., copy and paste) into the system, retrieved automatically from email or online communication portals, and/or collated from all locations into the system into the matter specific interface. In some embodiments, only an administrator may upload documents, edit information, and/or delete content/information from the matter specific interface. Alternatively, each user may have select privileges, for example, for adding communications, uploading documents, etc.

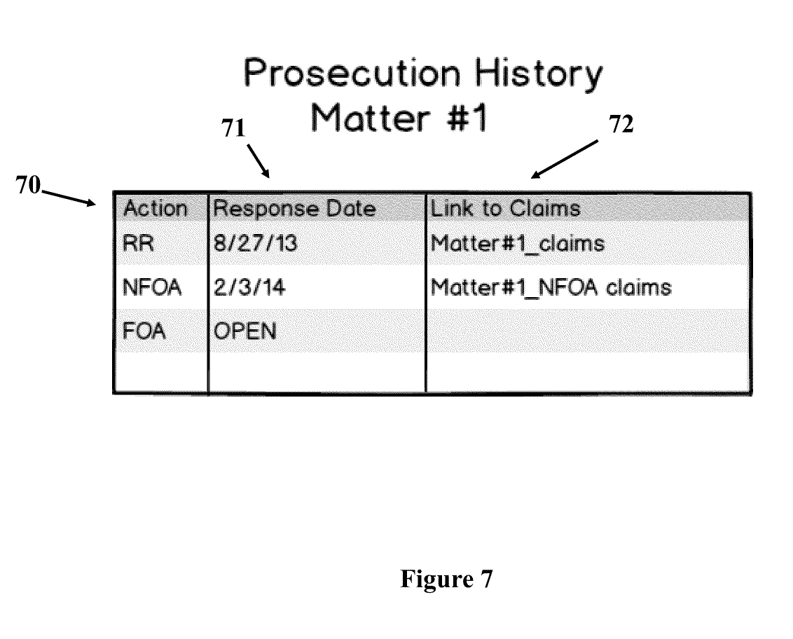

As shown in FIG. 6, the matter specific interface for each IPA may further include several user interface controls 64 (e.g., buttons, hyperlinks, etc.) for navigating to various interfaces of the system. For example, a user may select: “prosecution history,” “pending claims,” “rejections,” “signatures,” “family,” “bibliographic data,” “related claims,” and/or “response options.” Selection of each of these user interface controls 64 may present the user with a new interface pertaining to the selected user interface control. For example, as shown in FIG. 7, selection of the “prosecution history” user interface control may present to the user the prosecution history 70 of the IPA. In some embodiments, the prosecution history may include the history of action types received, the history of amendments made, the dates responses were filed, the prior art cited against the IPA, signatures submitted for the IPA, declaration deadlines for trademarks, notifications related to post issuance proceedings, and/or any other information relevant to the prosecution of the IPA. Each prosecution history item may be presented with a date 71 on which the notification was received, the response was submitted, the proceedings were completed, and/or any other type of date. For example, for a patent application, the prosecution history may include a restriction requirement issued on Jan. 2, 2012, a non-final office action issued on Jun. 10, 2012, a final office action issued on Dec. 7, 2012, a request for continued examination filed on Feb. 14, 2013, and a non-final office action issued on May 13, 2014. In some embodiments, each prosecution history item includes attached documents and/or hyperlinks 72 to relevant information, for example, claims sets, signed declarations, arguments, etc.

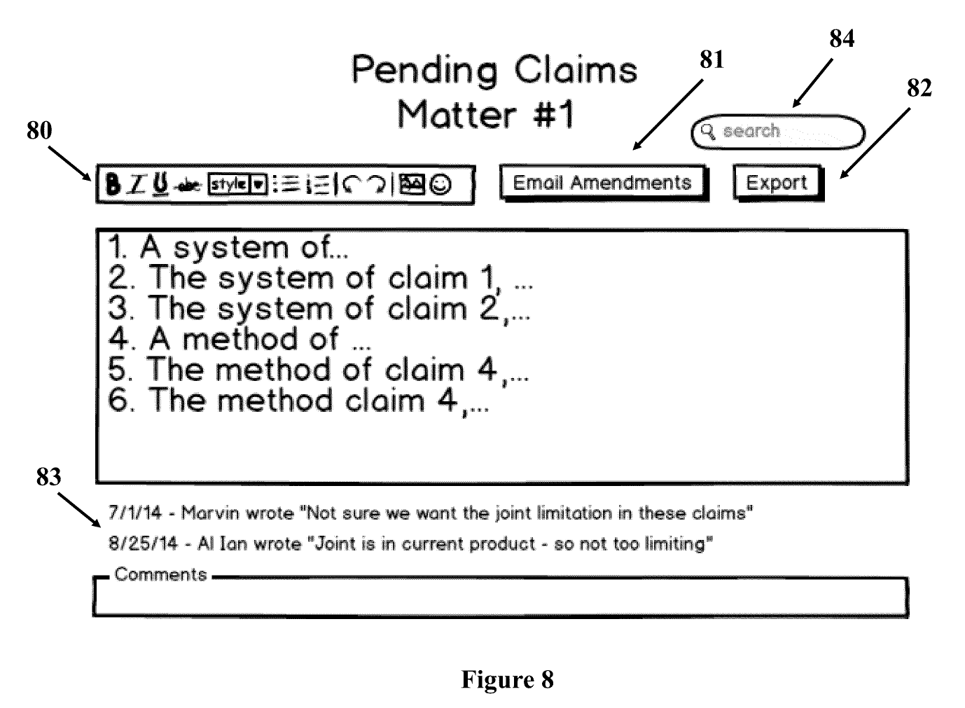

Now turning to FIG. 8. In some embodiments, claims, specifications, marks, documents, and/or any other content may be amended, edited, restructured, or otherwise changed using the system. The content may be editable from directly within the system. In some embodiments, upon completing edits within the system, the system generates an appropriately formatted document for filing a response with the relevant IP Office. For example, claims in a patent application may be amended, as shown in FIG. 8. In some embodiments, the currently pending claims may be presented to the user for amending, editing, restructuring or changing the claims. A user may accept all the amendments that were filed in the last response to yield the currently pending claims so that new amendments may be made for a second response. In some embodiments, the system may automatically generate and present the currently pending claims by accepting the amendments that were filed in the last response. Alternatively, if no amendments have been made, the system may present the claims as filed. Alternatively, the currently pending claims may be downloaded, transferred, or otherwise procured from a database (e.g., PAIR, Espacenet, Google Patents, etc.). The “pending claims” user interface may include a set of tools 80 (e.g., bold, italic, underline, undo, redo, etc.) for modifying the pending claims. The system may review the revised claims and ensure that they are in accordance with USPTO rules, for example, underlining added text, striking through deleted text, and/or determining proper antecedent basis for claim elements. Additionally or alternatively, the system may indicate where in the specification the claim language is provided. For example, the system may highlight where key terms in the claims or phrases in the claims are present within the specification. The system may generate an alert to the user if terminology added into the claims is not present within the specification as filed.

Additionally or alternatively, in some embodiments, the system may indicate other locations in a patent portfolio where the claimed subject matter is disclosed. For example, the system may highlight other applications and/or patents in which the claimed subject matter exists. The system may provide the titles and other bibliographic information for said other applications and/or patents; additionally or alternatively, the system may provide full text of said other applications and/or patents with relevant portions of the text highlighted.

In some embodiments, multiple users may review and/or comment on drafted or pending claims. The comments 83 may be date and/or time-stamped such that amendments to and/or comments on the claims may be tracked over time. In some embodiments, a “chat” button may be included, such that the user may message or chat (text, video, and/or voice) with another user regarding proposed amendments, edits, content, and/or any other information regarding the IPA. In some embodiments, the text or voice conversation may be stored for future reference. In some embodiments, a user may send, transmit, or otherwise transfer the pending claims to another user in the system or external to the system, for example, using an “email amendments” user interface control 81. Additionally or alternatively, a user may export 82 the pending claims, for example, to text, Word, pdf, or any other format. In some embodiments, a search field 84 may be provided, such that the user may locate terms, language, and/or text within the content and/or information in the interface.

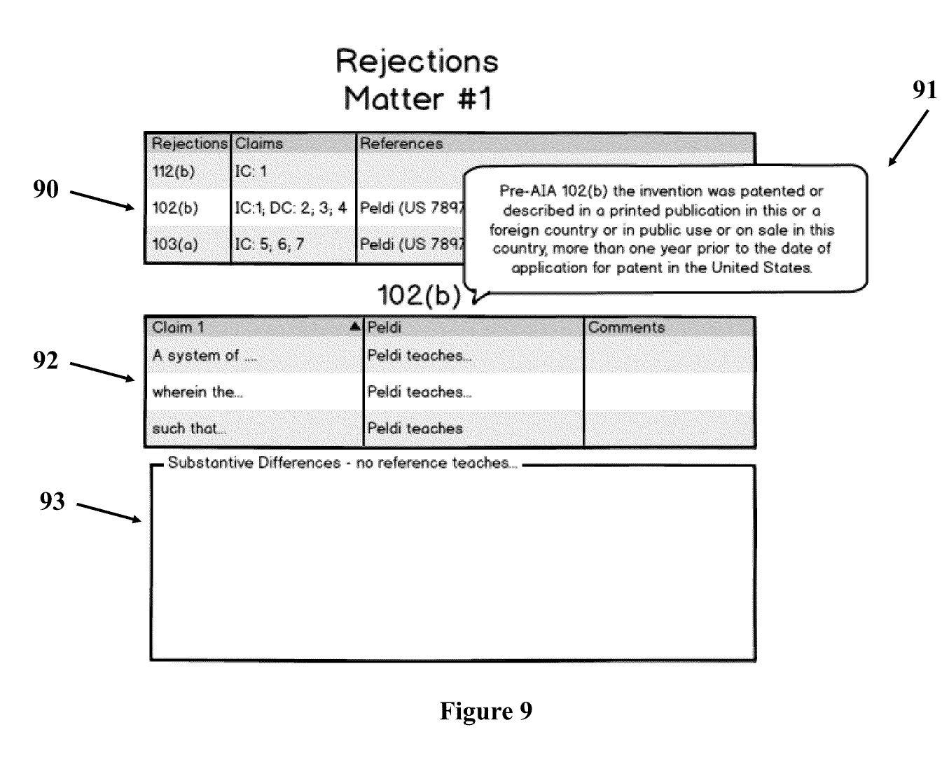

In some embodiments, as shown in FIG. 9, the system may present to the user the rejections cited by the USPTO or any other IPA granting authority. The system may present the current claims, as shown in FIG. 8, the examiner's rejection(s) 90, and the portion of the prior art reference that the examiner has cited to make his/her rejection 92, as shown in FIG. 9. The references may include patents, patent applications, design patents, design patent applications, trademarks, copyrighted material, publications, public notices, websites, and/or any other type of content in the public domain. The rejections may be rejections from the United States or a foreign intellectual property office, judge, examiner, or any other individual contributing to the review and/or granting of intellectual property applications. In some embodiments, the rejections may be based on codes, regulations, rules, and/or any other type of protocol used to evaluate and/or grant intellectual property applications. Figures and/or text may be extracted, copied, and/or duplicated from the reference and/or office action and included in the “rejections” interface.

In some embodiments, if the examiner's rejection information is provided, the system indicates the type(s) of rejection(s) 90 that has been issued and a definition 91 of the rejection. The definition 91 may be provided by the system in a pop-up when the user's cursor hovers over the rejection, in a footnote on the interface, as a link to a definition's interface, or any other type of mechanism. For example, if the examiner has rejected the claim under a §102 rejection, the system may present information to explain that this means that the examiner has found all elements of the claim in the cited reference. The portion of the prior art reference may also be presented. In some embodiments, the current claims are broken down by claim element and the rejection is provided separately for each element 92. In some embodiments, the document may be manually created by combining information from the user's current claims, the examiner's office action from the USPTO, and the text and figures of the prior art reference. Once created, the document may be uploaded to the system. Alternatively, the document may be created automatically using a separate system or algorithm, or the system may create the document. For example, the system may use OCR on the office action text and then parse the data to determine the patent numbers referenced/cited. The system may be asked to find all publication numbers, including the prior art publications referenced by the examiner. The system may then access the full text of the publications to extract the relevant paragraphs. The data may be extracted using various algorithms and APIs and then combined and presented in a usable fashion. In some embodiments, one or more users may analyze the rejections and enter substantive differences that they identify and/or suggested amendments into a data entry form 93 in the user interface. A user may collate, write, and/or otherwise input the substantive differences into a user interface, as shown in FIG. 9. In some embodiments, a user may use a highlight function to highlight portions of the specification not disclosed in the cited references. In some embodiments, the substantive differences may inform other user interfaces and/or databases. Additionally or alternatively, the user may navigate to the “pending claims” interface to amend the claims based on the cited reference(s).

In some embodiments, the bibliographic information about the references may be collated, collected, or otherwise aggregated into a form, for example, an information disclosure statement (IDS), for submission to an intellectual property office, for example, the USPTO. In some embodiments, an IDS may be filed in the pending IPA and/or in a co-pending related IPA in the portfolio. In some embodiments, a user may manually enter references into the system for inclusion into an IDS at the present time or a later date. Alternatively or additionally, search results may be uploaded into the system, for example, for inclusion in an IDS. The search results may be derived, for example, from a patentability, freedom-to-operate, product clearance, validity, and/or state of the art search. In some embodiments, the system may automatically populate the IDS form with publication date, issue date, inventor name and/or applicant name of each reference or publication, for example, using publically available databases (e.g., Google, PAIR, Espacenet, etc.). In some embodiments, the applications, patents, marks, and/or documents pertaining to the search results may be uploaded into the system and/or located in a database and tagged by the system. In some embodiments, a user may select to copy, move, or otherwise transfer all or a subset of the search results into a user interface and/or a form, as described above, for submission to an intellectual property office. Additionally or alternatively, the search results and/or form may be sent to another user, for example, a law firm, for submission of the information to another user, for example, an intellectual property office. In some embodiments, a summary and/or user interface for all or a subset of the search results may be created; in some such embodiments, an exemplary claim, exemplary figure, and/or bibliographic data may be collated for each search result. The summary interface may be stored locally or remotely and be accessible through the system such that the user may reference the summary interface before, during, and/or after responding to a notification.

In some embodiments, the system may autogenerate an IDS before a deadline, for example, three months before filing a national application or before a first office action on the merits, and/or the system may generate an IDS for all or a subset of pending cases, such as cases that are directly related and/or cases that share one or more of the same technology categorization tags. The IDSs for other pending cases may be generated when a user first learns about a new reference or when the reference has been in the system for a specified period of time, for example, three months. The system may track and/or indicate which IDSs an examiner has considered.

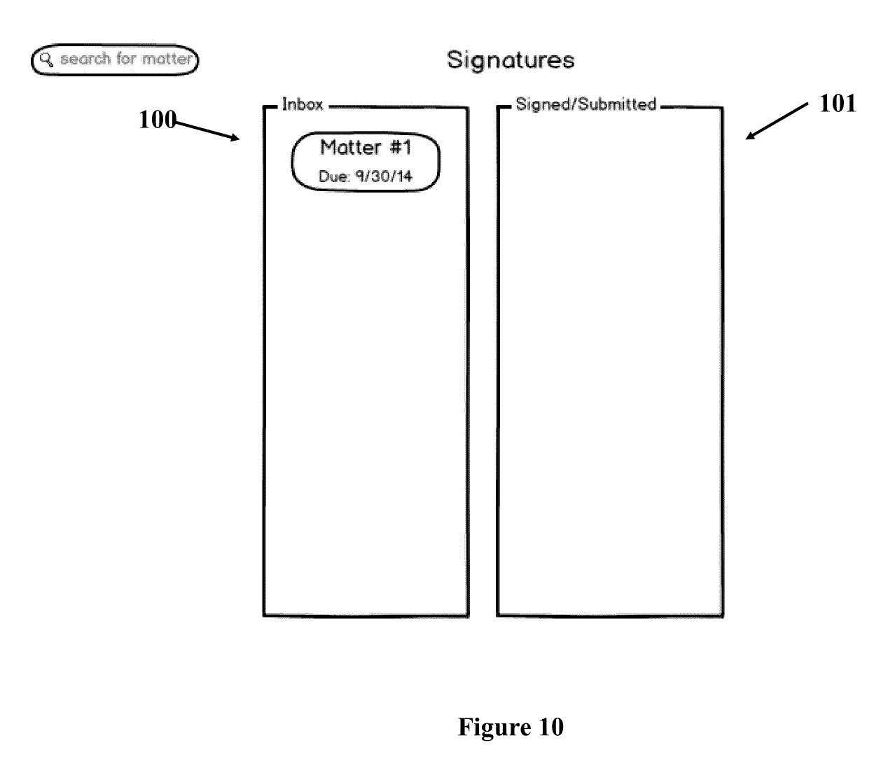

In some embodiments, as shown in FIG. 10, the system may present to the user outstanding documents for signature related to the IPA or enable a user to generate documents for signature. For example, within the Admin Portal, a user may be able to create documents such as invention disclosure statements, inventor declarations, assignment documents, mutual/one way nondisclosure agreements, power of attorney documents, application data sheets, cover sheets, or any other suitable documents. Within the Admin Portal, the user may be able to send documents out for signature, track receipt of those signatures, and file or record those documents with the appropriate systems. For example, with respect to declarations or assignments, the system may have the document text stored or may use a template document provided by the USPTO. In some embodiments, the system may provide to the user an interface for signing nondisclosure agreements (NDAs), such that the user may sign an NDA at any point in time through the system. A user may fill out a form that requests inventor information, title, patent number, or any other information, and the system automatically creates the document by filling in the fields with the provided information. In some embodiments, the information that the inventor uses to fill out the forms may be stored and/or used by the system to verify data on an application filing receipt or any other document. In some embodiments, the system may send a document, for example, an assignment for recordation, to the USPTO once an application reaches a certain status, for example, when an application publishes.

The system may also provide documents for signature that may be presented to a user in the “signatures” interface or sent to an email address, a social media address, or other web-enabled address. The system may receive authentication and then allow the person to sign the document using an approved USPTO form of signature (e.g., the “S-signature”). For example, the system may only allow the user to select the /James Smith/ option which meets the USPTO requirements for an electronic signature. The system will track receipt of the signature(s) and compile the document(s) for filing. The system may file the document directly. Alternatively, the system may coordinate (through an API or otherwise) with a system such as DOCUSIGN or HELLOSIGN to obtain the signatures. In some embodiments, the system limits the e-signature options and formats available to the user to ensure the signature meets relevant patent office requirements. If attempts to reach an inventor are unsuccessful, after an appropriate number of attempts or a diligent effort (diligent effort may be defined by the Manual of Patent Examining Procedure §409), the system may prompt the user to execute and file a substitute statement by the other joint inventor(s) in lieu of an oath or declaration of the unavailable joint inventor. In some embodiments, as shown in FIG. 10, once the signature has been received, the system may transfer the signed document from the “inbox” bin/column 100 to “signed/submitted” bin/column 101, such that the user can visually confirm completion of the task.

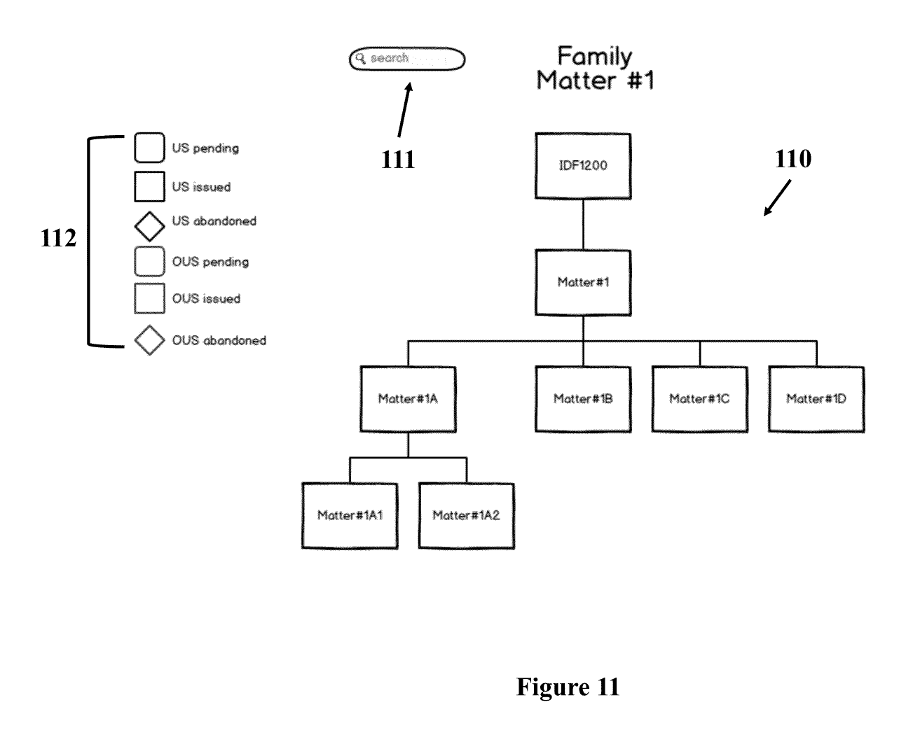

In some embodiments, as shown in FIG. 11, the system may present to the user a family map 110 of the family members of an IPA. The family members are related by continuity data. A family map 110 may include priority data, filing dates, pendency, IPA status, continuity data, and/or relationships between IPAs. For example, continuity relationships (e.g., continuation, divisional, continuation-in-part, etc.) may be denoted for each of the family members. In some embodiments, a key 112 may be included with different symbols, lines, shading, and/or coloring that indicate a status, pendency, or other feature of an IPA. For example, a square may indicate an issued or granted IPA whereas a rounded square may indicate a pending IPA, as shown in FIG. 11. In some embodiments, as shown in FIG. 11, the family map 110 may be searchable 111. In some embodiments, a user may long press with a finger or stylist, double click, hover over with a cursor or mouse, or otherwise select an IPA in the family map 110 to view additional information about the IPA. For example, a figure, claim, category, and/or other feature of an IPA may be revealed. In some embodiments, when a user selects a family member that is a continuation-in-part, the system may provide to the user the subject matter that was added in the continuation-in-part.

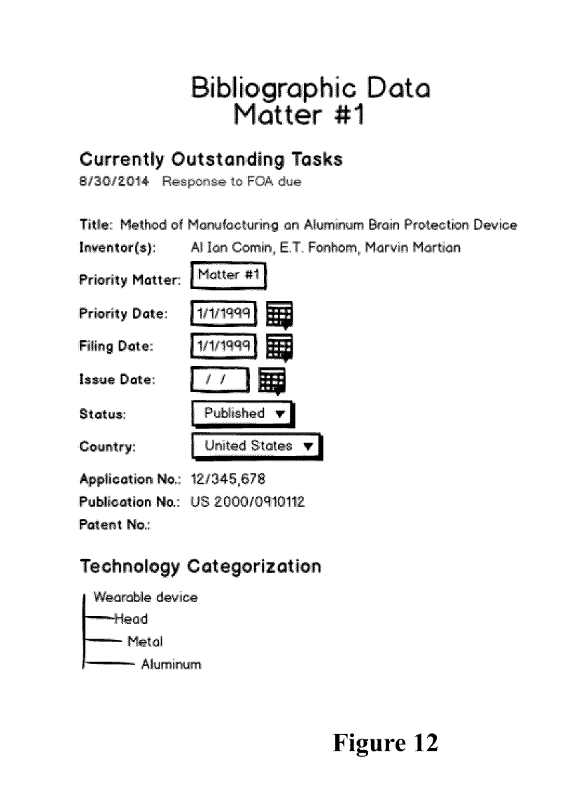

Additionally or alternatively, a user may select an IPA in the family map to view full details about the IPA in the family map. In some embodiments, as shown in FIG. 12, bibliographic data, family map, taxonomy or categorization data, claims or marks, and/or related claims, disclosure, content, or marks may be viewable by a user. For example, the bibliographic information, as shown in FIG. 12, may include any currently outstanding deadlines, an application and/or serial number, filing date, priority date, publication date, publication number, issue date, issue number, application type, examiner name, attorney name, docket number, intellectual property art unit number or categorization number, international patent classification number(s), inventor name(s), entity status, IPA status, continuity data, contact information, and/or any other pertinent bibliographic data. In some embodiments, the bibliographic data may be entered and updated manually, automatically from an external database (e.g., PAIR, Google, Espacenet, et.), and/or automatically from notifications received by the system (e.g., emails, office actions, etc.).

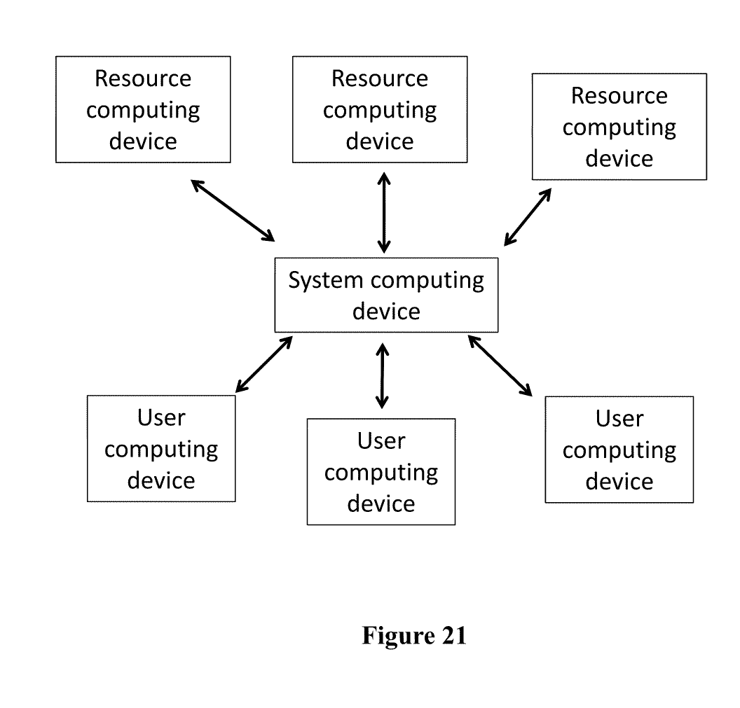

In some embodiments, the figures, specification, and/or claims of an IPA may be viewable, such that the user may choose a subset of the figures, specification, and/or claims for inclusion in a presentation generated by the system. For example, a user may choose FIG. 21 and claim 3 as an exemplary figure and claim, respectively, for use in a presentation. Further, information from other databases may flow, be copied, or be transferred into the presentation. In some embodiments, the presentation may be exported, sent, saved, or otherwise used outside of the system.

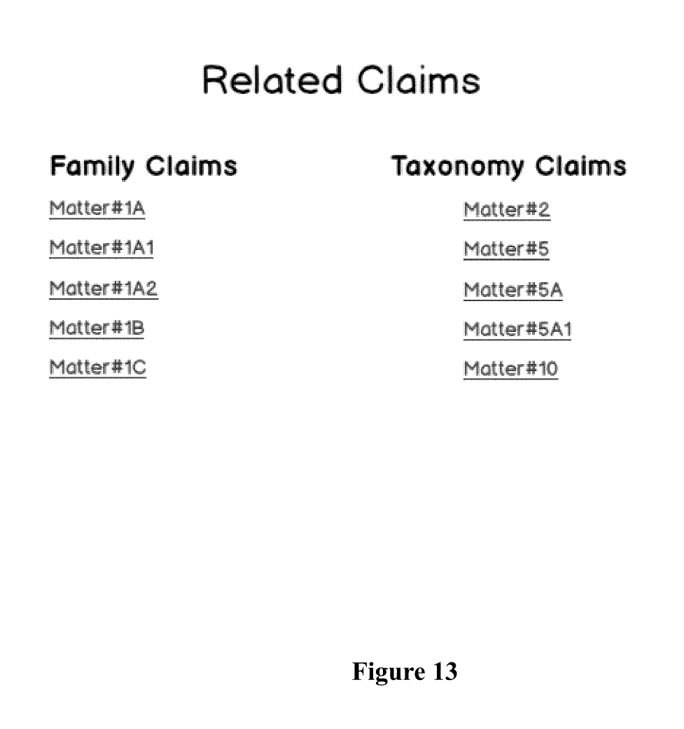

In some embodiments, as shown in FIG. 13, the system may present to the user a variety of claim sets that are related to an IPA. For example, the related claims may include the amendment history of the claims of the IPA. Alternatively or additionally, the related claims may include claims from the portfolio, the family members of the patent application, a competitor's portfolio, and/or a reference, which may be similar to the pending claims and/or inform a decision regarding the pending claims. The claim sets may be provided as hyperlinks, such that the user may select the link to view the claim set. The claim sets may be in read-only, editable, and/or downloadable format. The claim sets may be opened in the “pending claims” interface, such that the claim set may be reviewed and/or edited.

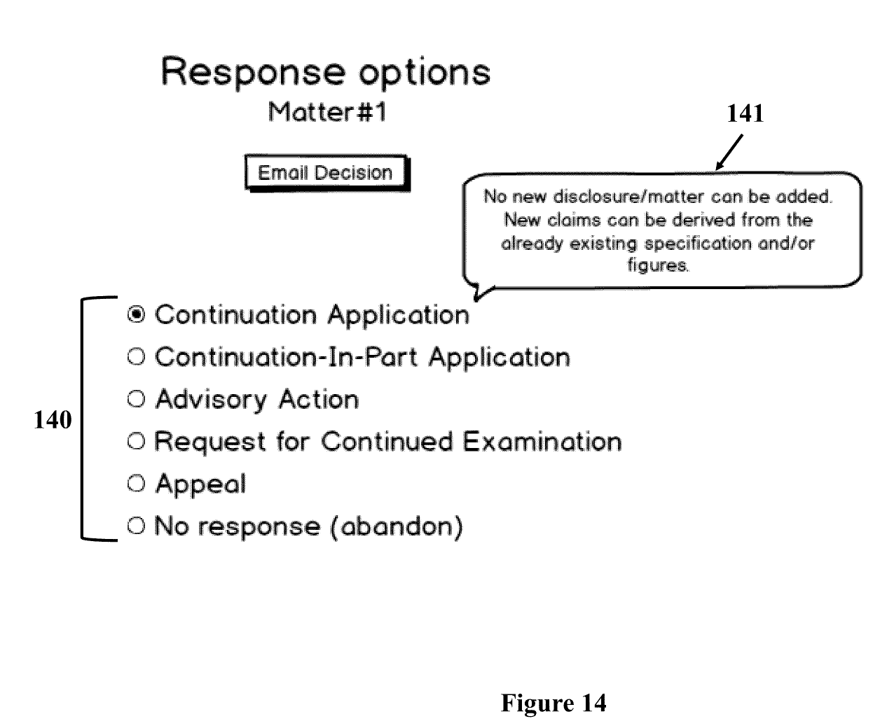

In some embodiments, as shown in FIG. 14, the system may present to the user a set of response options that the user may select to respond to a particular notification, for example, a final office action from the USPTO for an IPA. The system may detect the type of notification received and provide to the user a set of response options 140, fee schedules, response timing, and/or turn around time that the user may consider when evaluating when, how, and/or whether to respond to the office action. For example, as shown in FIG. 14, the system may indicate that to respond to a final office action, a user may file a continuation application, a continuation-in-part application, submit a response within two months (and elicit an advisory action), submit a response after two months along with a request for continued examination, file an appeal, or not respond (eliciting abandonment). Further, the system may provide explanations and/or definitions 141 to the user as to the meaning and/or purpose of each response option. In some embodiments, the system may also provide fee information for submitting each response type, for example, by providing a link to the USPTO's fee schedule. The fees may be determined by the United States or a foreign intellectual property office, a law firm, annuity service, and/or any other type of user.

In some embodiments, a response option may include interviewing the matter with the examining patent examiner. If a user selects the interview option, the system may provide information related to the examiner, for example, from a database. For example, the system may provide information about other IPAs currently in prosecution with the same examiner (i.e., that could also be interviewed) and/or other IPAs by competitors that are in the examiner's docket. In some embodiments, the system may provide response strategies based on statistics about how specific examiners, art units, and/or intellectual property offices respond to user responses, for example, using PatentCore or Patent Advisor from LexisNexis®. Further, the system may provide information about success, allowance, abandonment, response times, and/or other response rates for a particular examiner, art unit, and/or intellectual property office.

As an alternative example, when the IPA is an inventor(s)'s invention disclosure, the response options may be related to filing decisions. In some embodiments, the response options may include File a Non-Provisional Patent Application, File a Provisional Patent Application, Publish, Review, Reconsider, Hold as Trade Secret, Do Nothing, and or any other suitable response. In some embodiments, a user may provide their feedback on value and/or importance of the invention. For example, a user may provide comments or a numerical score with respect to infringement detectability and ease of design around, importance to company, importance to competitors, likelihood of success, and/or any other suitable characteristic. In some embodiments, the rank or score the invention receives may be used to determine the response option choice.

Further, an estimated time frame for response and/or turn around may be included. For example, the system may provide an estimate of the duration of time expected between when a response of a certain response type is filed and when the next action will be received. In some embodiments, the response and/or turn around time may be provided by a database. Alternatively or additionally, the response and/or turn around time may be calculated from data provided by a database.

A user may indicate through a control, as described above, a response type, and the specified response type may be sent, for example, through email, to another user. In some embodiments, the system may provide the user with a response template once the user selects a response type. The system may autofill any information into the response template and notify the user that the response is ready for editing and/or reviewing. The system may automatically upload the response to an online portal, for example, the USPTO's electronic filing system, for submission. Alternatively, the user may download the completed response and then upload the response for electronic filing or paper file the response.

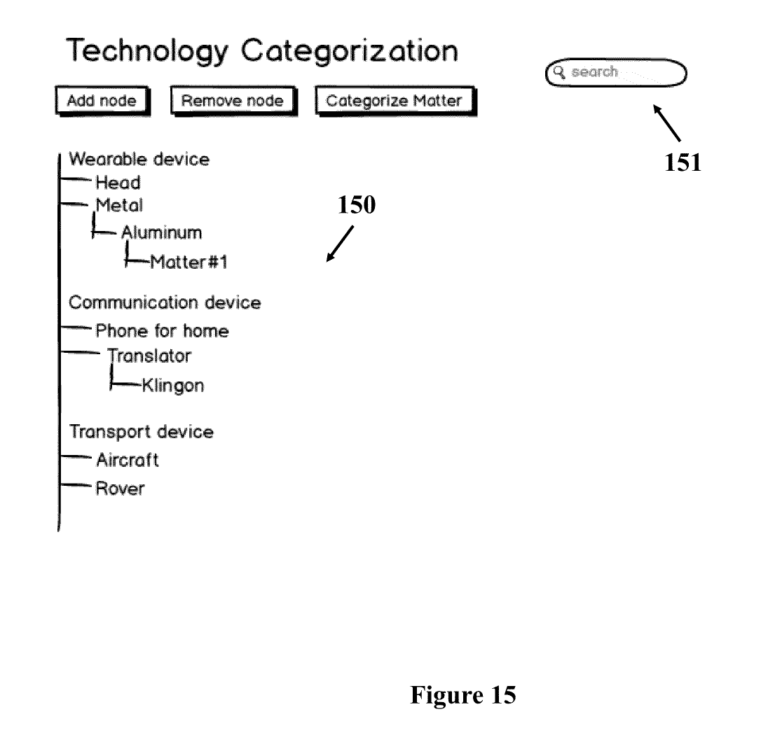

In some embodiments, as shown in FIG. 15, each IPA in a portfolio may be categorized by technology into a taxonomy 150. The technology, invention, or mark categorization or taxonomy may include categories and subcategories, root nodes and sub-nodes, groups and subgroups, or any other type of information dissection, segregation, parsing, or differentiation. As shown, in some embodiments, the taxonomy is presented in a selectable taxonomy tree; in some such embodiments, selecting a portion of the tree, expands the tree to reveal subcategories and/or particular matters grouped within the selected portion of the tree. The categories, IPAs in the categories, and/or other parameters may be searchable 151. In some embodiments, technologies, inventions, or marks within the same category may include claims and/or disclosure, for example, directed towards similar subject matter. In some embodiments, the system may correlate claim content with specification content in a patent application, such that the specification content shows the support for the claim content. In some embodiments, when content is modified, changed, edited, or amended, the content may automatically update in the categorization or taxonomy. Alternatively, a user may choose to inactivate this functionality.

The taxonomy may be autogenerated by the system, for example, using algorithms to detect the most commonly used terms in the portfolio, and each IPA, for example, the claims, specification, and/or figures, may be automatically categorized into the taxonomy. Alternatively, the taxonomy may be manually generated by one or more users, and each IPA may be manually categorized into the taxonomy, for example, by an admin user. The taxonomy may also grow and change with the portfolio, such that nodes may be added, deleted, or rearranged. Alternatively, IPA categorization may be provided by an external service, for example, PatentVista by TechInsights® or IPfolio®.

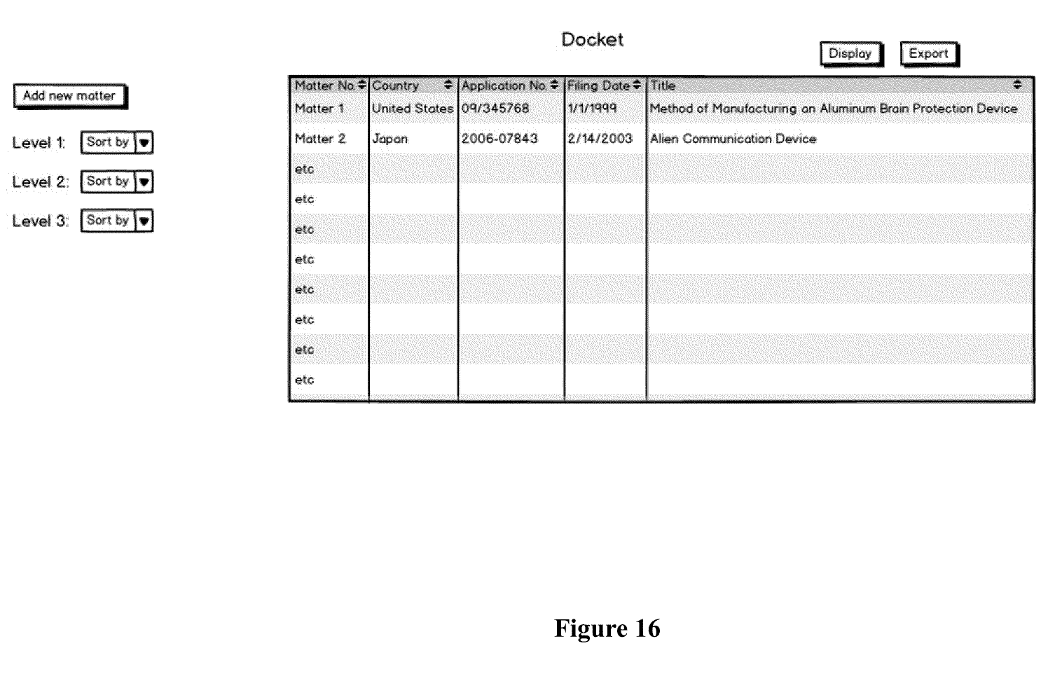

In some embodiments, as shown in FIG. 16, the system may further include a docket. The docket may include country rules, deadline generation based on input dates, bibliographic data, record keeping, and/or any other parameter. Alternatively, the docket may be provided by outside counsel, such that relevant information, for example, deadlines, are imported or loaded into the system, for example, through receipt of a notification. Alternatively, the docket may be managed by an external service, for example, AppColl®, Cardinal IP®, CPA Global®, or any other external service, and relevant information imported or loaded into the system.

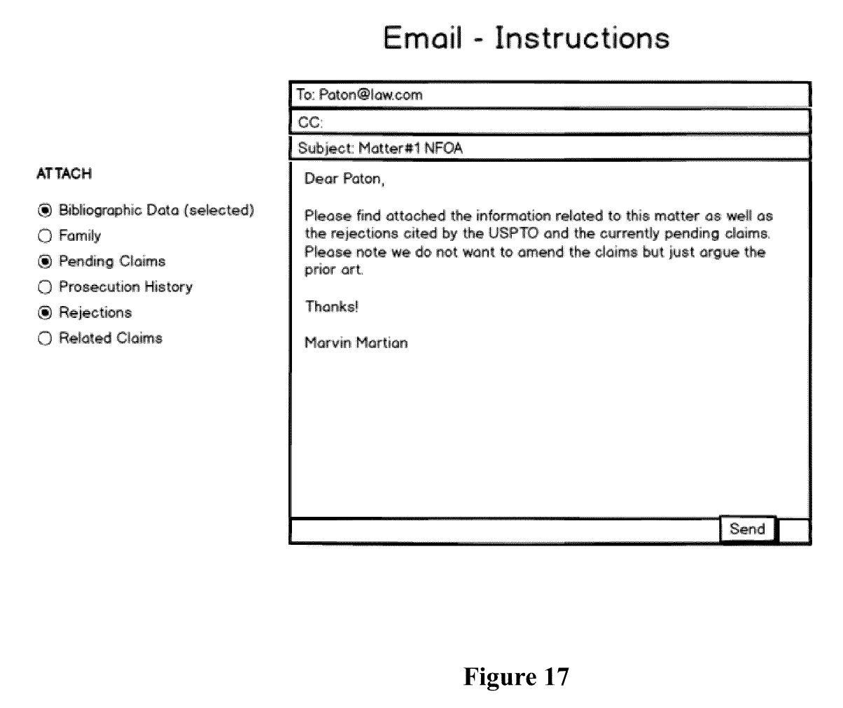

In some embodiments, as shown in FIG. 17, the system may further include an email interface. The email interface may be compatible with iCloud®, Microsoft® Outlook®, Gmail®, or any other type of email provider. For example, a user may send suggested claim amendments, edited documents, instructions for responding to an action item for an IPA, and/or other correspondences. In some embodiments, the email may be a notification that includes information shared with a database, annuity service, user, docket, the United States or a foreign intellectual property office, law firm, and/or other user of the system, as described above. The system may provide a list of attachments related to an IPA or a set of IPAs that may be included with the email. In some embodiments, communications through email may be transferred by the system to the matter specific interface, such that a user may view and follow a communication history of an IPA.

Further, the system may also include a patent term adjustment (PTA) calculator based on, for example, rules outlined by the USPTO and PAIR data. In some embodiments, the system may manually or automatically send a Request for Reconsideration of Patent Term Adjustment to the USPTO based on the calculations from the PTA calculator. Alternatively, a user may wish to forgo this functionality.

In some embodiments, the system may provide a “diligence support” interface. Within the “diligence support” interface, the system may provide an option for selecting from various reports that the system can generate. In general, the system may automatically create the reports, for example, by accessing data or other information through an API or from data stored within the system and/or on a user's server or a remote server. Alternatively, the reports may be created manually or through a separate system or algorithm and uploaded to the system. In this embodiment, the reports may be updated periodically (e.g., daily, weekly, monthly, quarterly, etc.) or on an as needed basis, either upon request or upon the receipt of new information.

For example, the reports generated by the system may include drawings, brochures, and written description of the current product(s) and products under development; a complete listing of the entire IP portfolio; copies of pending patent applications that have not yet been published (and related search reports and/or Office actions); copies of patent applications that have been prepared or are being prepared but are not yet filed; copies of all documents relating to ownership of intellectual property, both asserted and executed, including, without limitation: assignments of patents/patent applications to the company; results of any prior art searches that have been conducted and identification of key prior art; documents relating to any third party rights in any product designs, patents, or patent applications (e.g., security interests, etc.); copies of any opinions of counsel regarding any pending matter, inventorship, inventorship compensation, patentability, validity, or potential infringement (e.g., patentability reports, freedom-to-operate studies, etc.); copies of any communications asserting that the client is infringing third party patent rights; identification of all litigation and threatened litigation in which the client is or could be involved, and all related documents; identification of all litigation and threatened litigation in which the client is or could be involved, and all related documents; identification of all administrative disputes (including, without limitation, oppositions, interferences, inter partes review, and reexaminations) in which the client is involved, and all related documents; all patent licenses granted to, or any patent licenses taken from, third parties, and all other agreements relating to any kind of intellectual property; identification of all third parties the client believes are potential infringers of the client's patent rights; identification of all patents that the client's products might possibly infringe; a list of all trademarks that the client uses in conjunction with its products; a list of all US and foreign trademark applications and registrations; any communication from third parties relating to trademark infringement, unfair competition, false or misleading advertising or the like, and/or any other type of report and/or documentation. Alternatively, any report that a company might wish to generate to respond to a third party request may be generated by the system. For example, the assignments report may collate a copy of each of the most recent assignments recorded for a particular IPA with the USPTO. For the employment and consulting agreements, the system may generate a report of all agreements or alternatively may only include agreements for all listed inventors on any IPAs. For the references cited during prosecution, the system may maintain a list of all references cited and in how many unique IPAs that reference is cited. The report may rank the references by the frequency that they are cited against the portfolio. In some embodiments, the system may enable a user to review all office action responses in which a particular reference was cited, such that a user may determine the best argument/amendments for overcoming the reference.

Further, within the admin portal or within a separate portal, a user may create and review budget information. A user may be able to upload invoices. The system may read invoices and tie the billing information to each matter. The system may be able to group billing information by category, for example, IDS creation, office action review, drafting, patent application. The system may be able to group billing information by matter, type, and date range so that it can predict the cost of activities, such as drafting a patent application or responding to an office action within a time frame.

The system may be able to provide a chart or other representation of the information for future projections of the IP budget. For example, it may display that 60% was spent on new filings, 30% on prosecution, and 10% on administrative activities or overhead. The system may allow a user to tag billing information into categories. The system may coordinate with existing financial systems such as MINT.COM for a similar way of tagging, sorting, and presenting financial information. The system may also have algorithms to calculate an annual IP budget estimate. For example, information such as attorney billing rate, IPA identification numbers, preferred countries in which the company files patent applications (could be specific to technology, patent family, etc.), or any other suitable information could be entered. The system may also store or access data from the USPTO such as average time to first office action, average time between first and final office action, average number of applications that go through RCE or appeal, or any other suitable information. Further, in some embodiments, that information is provided for a specific technology categorization, patent family, filing date, art unit, patent classification, assignee, or examiner. The system may also store or access data from prior invoices and/or budgets, such as the average cost of patent filing, the average cost of office action response (by country or response type), and average admin spend per application or per action. Further, that information could also be specific to technology categorization, patent family, filing date, art unit, patent classification, law firm, or any other suitable information. The system may then predict when a patent asset will be receiving various actions and how much each of those actions will cost. The system may also factor in government (e.g., USPTO or WIPO) filing fees, admin fees, and/or annuities and the timing of those fees. The system may allow the user to modify or try different scenarios to create the budget. The system may allow the user to save different versions of the budget and allow a user to export charts or graphs from the system. By comparing different scenarios, the system empowers the user to make decisions on: abandoning applications in specific countries, the number of new applications filed, abandoning after final rejection (e.g., rather than filing an RCE or appeal), taking extensions of time to defer costs, or any other matters requiring a decision.

In some embodiments, the system may also include a competitor portal. The competitor portal may track competitor activities and any other information related to competitors. The competitor portal may include information such as newly filed or published patent applications, recent claim amendments, full application and PAIR data from competitor portfolios, news updates about competitors, and any other suitable information. The competitor portal may also include searching capabilities for determining the relevant information. The competitor portal may include an alert option, such that IPAs with a particular title, content, filing date, publication date, issue date, assignee, inventor, and/or any other information may be downloaded, tagged, or otherwise indicated or collected by the system and/or sent to a user. In some embodiments, information from monitoring competitor IPAs may be used to trigger an option for submitting prior art in connection with a pending or allowed IPA, for example, a pre-issuance submission or post grant review. In some embodiments, when a competitor's patent application receives a notice of allowance, an alert and/or option may be triggered that enables the user to decide to initiate a post grant review within nine months. In some embodiments, when a competitor's patent receives a notice of allowance and/or issues, an alert and/or option may be triggered that enables the user to decide to initiate an inter partes review within nine months of grant of the competitor's patent or after the completion of a post-grant review. Alternatively, any other type of alert and/or option may be triggered. For example, the system may include classification alerts, such that each new filing in an art unit, class, or subclass is monitored by the system.

In some embodiments, the system may also include an awards portal. For example, the system may track the number of IDFs, provisional and/or nonprovisional filings, and/or patent issuances and who the inventor(s) is/are of each IPA. The system may automatically generate an email or notice each week, month, quarter, year, or any other time frame for the client and/or each inventor indicating the awardees. The system may automatically send a notice to accounting or any other department, for example, to indicate that a monetary award should be added to an inventor(s) next paycheck or annual bonus and/or a gift card should be sent to the inventor(s). Additionally or alternatively, the system may automatically order a patent plaque for issued patents for the client and/or inventor. In some embodiments, the system may wait until a threshold amount of patents have been issued before ordering the plaques.

In some embodiments, the system may also include a billing portal. The billing portal may allow users to bill to certain clients, projects, and/or tasks. For example, a user may be able to start a clock at the beginning of starting a task or project and stop the clock at the completion of the task or project, such that the system tracks and saves the elapsed time. Alternatively or additionally, a user may be able to enter an elapsed time for a task or project. The user may submit hours for approval using the system. In some embodiments, a general budget, hourly rate, or flat rate fee may be indicated for each client, task, or project. In some embodiments, the system may calculate a tax liability (e.g., payroll taxes) for a user based on the total income, state of residence, etc. for a defined period of time. The system may be able to generate invoices and manually or automatically send invoices to a client. In some embodiments, a user may be able to generate a contract within the system or upload a contract to the system, for example, a contract between a law firm or patent strategy advisor and a client. In some such embodiments, the respective parties to a contract may be able to sign the contract directly within the system. Additionally or alternatively, the system may be able to extract the agreed upon payment terms from the contract and include those payment terms (e.g., hourly rates or flat rate fees) in the billing portal.

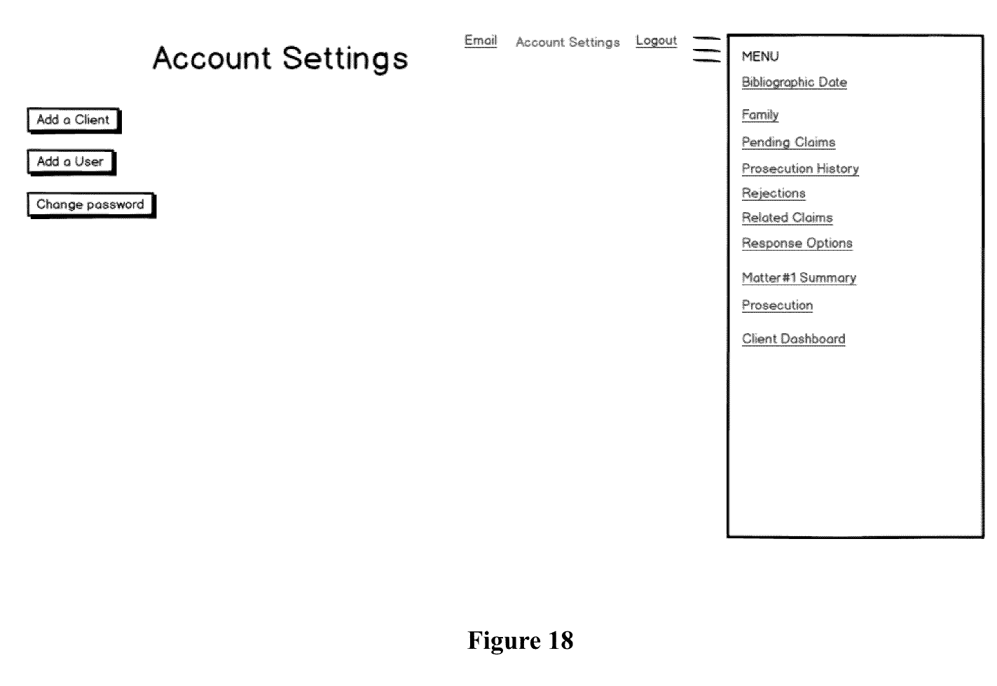

In some embodiments, the system may further include an “account settings” interface, as shown in FIG. 18. The “account settings” interface may enable a user to add users to the system, for example, a client, an admin user, or any other type of user. The “account settings” interface may enable a user to change security settings, for example, a password, a username, security questions, etc. In some embodiments, the “account settings” interface may enable a user to alter the permissions of a user, for example, from read-only access to an admin user. A user may be able to link various email accounts, calendars, or databases to the system through the “account settings” interface.

In some embodiments, any user interface of the system may enable a user or users to comment (text or voice memos), rate, or otherwise annotate edits, amendments, and/or changes made to a document, claims, specification, and/or any other type of content. In some embodiments, a chat, messenger, or other communication feature may enable multiple users of the system to almost instantly discuss, review, and comment on edits, amendments, changes, and/or information associated with an IPA. In some embodiments, meeting requests may be sent from and/or received by the system, such that a meeting may be started immediately or scheduled for a future date and/or time. Alternatively, other scheduling functionality, for example, viewing of user's meetings and/or schedule may be included.

In some embodiments, the system may include a rules database or a rules database may be accessible by the system. A rules database may be included to provide continuous updates as well as frame of reference for the user. The rules database may include all sources of patents, trademarks, copyrights and other related rules. Exemplary rule databases include the United States Code, the Code of Federal Regulations, The Manual of Patent Examining Procedures, Trademark Examining Procedures, the Copyright Compendium of Practice, Rules Relating to the Patent Cooperation Treaty, information pertaining to the various IP conventions including the Paris Convention, the Berne Copyright Treaty, and the official gazette of the USPTO.

In one example method or workflow of operating through the system, an inventor sends an invention disclosure form (IDF) in an email or otherwise uploads the IDF to the system. The IDF is automatically saved as a new card or new matter within the Invention Disclosure portal.

In some embodiments, the IDF is automatically mined for keywords. The keywords may be pulled from the title and/or frequent nouns appearing within the IDF summary/disclosure. In other embodiments, the IDF includes a user-fillable keywords entry line, from which the system pulls the keywords. In some embodiments, the system searches a database for prior art with those keywords and/or similar words. In some embodiments, the search results are automatically displayed within a format that is the same or substantially similar to the SB08 format for USPTO IDS submissions. The search results listed on the form may be provided as active links, which a user can click on or otherwise select to access a reference. In some embodiments, a user can select a classification number listed within a reference to review other references in that classification. Additionally or alternatively, a user can: email known references to the system, upload or import known references to the system, or manually enter information about references into the system. Doing so generates one or more new entries in an SB08 form or similar form. In some embodiments, manually entering an application, patent, or publication number into the system causes the system to populate all needed cells of an SB08 form.

In some embodiments, the user can create a new application template in the Application Drafting portal, for example, after submitting and getting approval for an IDF. The user can select the IDF from which the user wants to work. An application template may be generated with one or more fields of the application already completed, for example, as described above with reference to the Application Drafting portal. In some embodiments, during or after the generation of a new application template, the system may generate an Application Data Sheet, an inventor declaration, and/or an assignment document. Such documents may be accessible for the relevant parties to sign within the Signatures portal, as described above.

In some embodiments, a user can indicate through the system when the application draft is complete and designate other users who should review the application. Notifications and tools for reviewing the application may be available to the designated reviewers. In some embodiments, upon filing an application, a user can mark the application in the Application Drafting portal as filed, and a prompt appears requesting the application/serial number of the filed application. Upon user entry of the number, the matter may be automatically moved to the Prosecution portal and listed as a new card/matter in the “Awaiting Office Action” bin or column. In various embodiments, as described above with reference to the Prosecution portal, the system periodically pulls information from one or more databases, such as the USPTO PAIR system, to update the card/matter when a new action is received or a new response is filed. The system may automatically docket deadlines and generate an updated prosecution history of each matter.

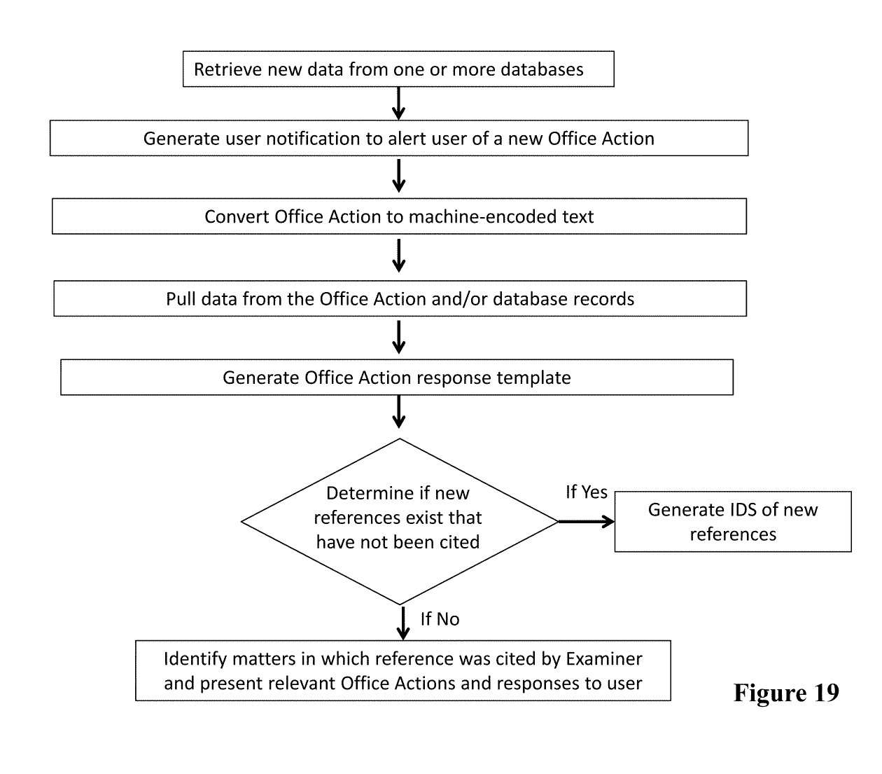

In another example method or workflow of operations performed by the system, illustrated in FIG. 19, the system regularly retrieves (i.e., scrapes) new data from one or more databases, such as PAIR or other patent office database or privately-maintained database. Upon detecting that a new Office Action has been added to a database, the system of various embodiments generates a user notification to alert the user of a new Office Action. The system updates its internal records to indicating an Action has been received. In some embodiments, the system retrieves the Office Action and automatically pulls data from the Office Action and/or database records. In one embodiment, the system converts images uploaded in the accessed database to machine-encoded text, for example, through electronic optical character recognition. In various embodiments, the system automatically generates an Office Action response template from the pulled data. Stock introductory language, conclusory language, recitations of the law, and/or other form language may be automatically inserted into the template by the system. Scraped information, such as application number, Office Action mailing date, Examiner name, applicant, due date, type of Office Action response, rejection types and cited references, may also be auto-inserted by the system into the template in the appropriate locations. In some embodiments, the previously presented claims are added with all previous claim amendments accepted. The claims may be editable, and any new insertion may be automatically underlined and any new deletion may be placed in double brackets or depicted with a strike-through. If the system receives a user input to modify a particular claim, the system of some embodiments automatically places “Currently Amended” or other user-selected language next to the claim number. In such embodiments, any previously amended claims are denoted as “Previously Presented,” new claims as “New,” and original claims as “Original.” In some embodiments, the insertion of a new noun, verb, and/or adjective into the claims causes the system to automatically search the specification as filed and highlight all uses of the added claim language within the originally filed text. In some embodiments, paragraph numbers for text of potential support is inserted into the response template or displayed to a user in a window or text box.

In some embodiments, the system additionally determines if any new references have been cited elsewhere in the IP portfolio (or specifically in a particular category within the portfolio) since the last IDS was filed. If new references have been cited elsewhere, the system may automatically generate an IDS listing those references.

The system of some embodiments further reviews the existing portfolio to determine if references cited in the new Office Action have been previously cited in other matters in the user's portfolio. In some embodiments, the system will generate an alert if an Office Action reference has not been previously cited in one or more existing matters in the user's portfolio. The user may be presented with the option to create a new IDS for each of those matters at the present time or delay creation of an IDS until the next Office Action response is prepared in each of those matters. In some embodiments, if a user chooses to delay creation of an IDS in one or more matters until the next Office Action response, the system will automatically create an IDS at the time of generating a new Office Action response template, as described above. In some embodiments, if an Office Action reference has been previously cited in other matters, the system reviews each of those other matters to identify the matters in which the reference was first cited by an Examiner in an Office Action. In some embodiments, the system presents a list of those matters to the user, and in some embodiments, the specific Office Action rejections and responses pertaining to the cited reference are presented to the user. The user can use this information to inform the user's Office Action response strategy, choosing, for example, to make similar amendments to overcome the reference, or to make different amendments to avoid redundancies in the portfolio.

Once an Office Action response template is generated by the system, it may be presented to the user in a web-accessible editable format or downloaded in an editable file format, for example, a Word file. A user may, at any time while completing an Office Action response, select to email the response to others for editing and/or reviewing. Moreover, in some embodiments, the system automatically uploads a completed response to an online portal, for example, the USPTO's electronic filing system, for submission. Alternatively, the user may download the completed response and utilize a more manual mode of response submission.

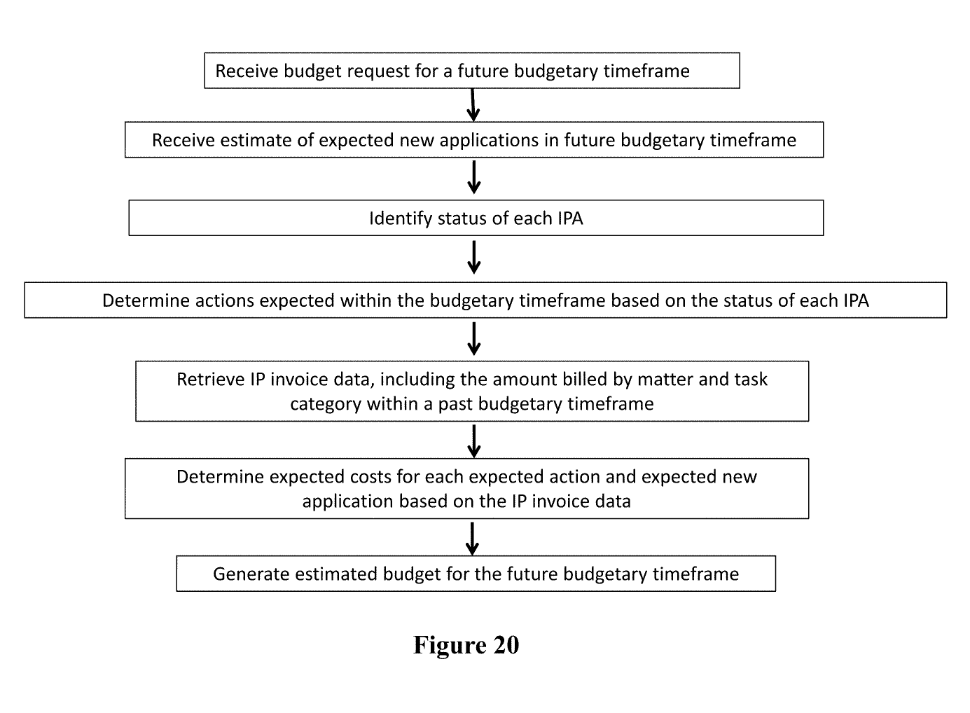

Another example of a method performed by the presently described IP portfolio management system is illustrated in FIG. 20. In the illustrated embodiment, the system is used to create IP portfolio budgets. In some such embodiments, a budget request for a future budgetary timeframe is received by the system from a user. The user may specify the duration of the future budgetary timeframe, such as, for example, for the next quarter or the next year. To improve the accuracy of the budget, the system may request and receive from a user an estimate of the number of new applications expected to be drafted and filed during the future budgetary timeline.

In some embodiments, the system identifies the status of each existing IPA. Identifying the status of each IPA may include accessing and scraping IPA data from PAIR or other patent office databases or it may include accessing the IPA status from an internal database. The internal database may be maintained with user-entered status data and/or data periodically scraped from PAIR and/or other patent office databases. The status may include, for example: a basic classification of each IPA (such as abandoned, expired, pending, or issued); a prosecution history (e.g., “filed 8 months ago and first action predicted in 10 months” or “3^{rd} Office Action/first non-final Office Action post-RCE received” or “7.5 year maintenance fee paid 24 months ago”); and/or assigned examiner, assigned art unit, filing date, and other application information. Based on the status of each IPA, the system of various embodiments is configured to determine the number and category of actions expected during the budgetary timeframe.

The system may also store or access historical data from the patent office, which the system uses to calculate average performance metrics, such as average time to first office action, average time between first and final office action, average number of applications that go through RCE or appeal, or any other suitable information. Further, in some embodiments, that information is provided for a specific technology categorization, patent family, filing date, art unit, patent classification, assignee, or examiner. In some embodiments, when determining the number and category of actions expected for a particular matter, the system takes into account the history of the particular matter (e.g., the time pending and actions received to date) and these average performance metrics.

As illustrated, in some embodiments of a method for determining an IP budget, the system additionally retrieves IP invoice data, including the amount billed by matter and task category within a past budgetary timeframe. In some such embodiments, invoices for IP services are periodically uploaded or imported by a user, for example, each time an invoice is received. The system may automatically convert the invoice to machine-encoded text, if not already formatted in such a manner, review the invoices to identify the billed amount and an associated matter number, and store the billed amount with the corresponding matter number within a database. In some embodiments, the system also identifies from the invoice a task associated with each billed amount and assigns the task to a category, for example, IDS creation, office action response preparation, and patent application drafting. The system may be able to group and store billed amounts by matter, task category, and date range. Further, that information could also be specific to technology categorization, patent family, filing date, art unit, patent classification, law firm, or any other suitable information. This stored IP invoice data is accessed and retrieved by the system when determining a future IP budget.

In various embodiments, the system is configured to predict future spending based on historical data. By identifying the average cost of various tasks performed in the past and adjusting for any changes to attorney billing rates and patent office fees, the system is able to predict the future costs of the same or similar tasks. Changes to attorney billing rates and patent office fees may be pulled by the system from invoice data or public or private databases or they may be entered by a user. Thus, by determining expected actions and expected costs of the expected actions, the system is able to predict future costs of an IP portfolio. Additional historical data may be used to further refine the estimates. For example, the system may save a list of countries in which an assignee has filed frequently in the past and use this list when estimating national phase filing fees for any matters entering the national phase within the budgetary timeframe.

The system of various embodiments may generate and output the estimated budget in a web-based format or as a downloadable file. In some embodiments, the system may allow the user to modify or try different scenarios to create the budget. The system may allow the user to save different versions of the budget and allow a user to export charts or graphs from the system. By comparing different scenarios, the system empowers the user to make decisions on: abandoning applications in specific countries, the number of new applications filed, abandoning after final rejection (e.g., rather than filing an RCE or appeal), taking extensions of time to defer costs, countries to file in, law firms to use, or any other matters requiring a decision.

By automating the document and data retrieval process from a plurality of databases, utilizing electronic optical character recognition to scrape all important data from retrieved documents, processing and synthesizing retrieved data, and layering the retrieved data with customized information, the systems described herein are configured to generate meaningful reports and insights that are not producible with existing software systems.

In some embodiments, the user may also utilize functions of the system to create technology taxonomies, family trees, patent portfolio statistics, and other reports. Through this described embodiment of a method and other methods discussed above, a user may be able to achieve comprehensive IP portfolio management using one seamlessly integrated system.

As shown in FIG. 21, the integrated system may include a plurality of computing systems communicating together. For example, the IPA management system of some embodiments includes a central system computing device, which may be web server or other computing device configured to retrieve, analyze, transform, and transmit data. In some embodiments, the central system computing device is in communication with one or more user computing devices, such as, one or more laptops, mobile computing devices, desktop computers, or other computing devices used by inventors, IP administrators, attorneys, and other users. In some embodiments, the central system computing device is also in communication with one or more resource computing devices. These resource computing devices include databases of IPA-related data and may be operated, for example, by one or more patent offices. In one embodiment, one of the resource computing devices is operated by the USPTO and is a server maintaining the PAIR data repository.

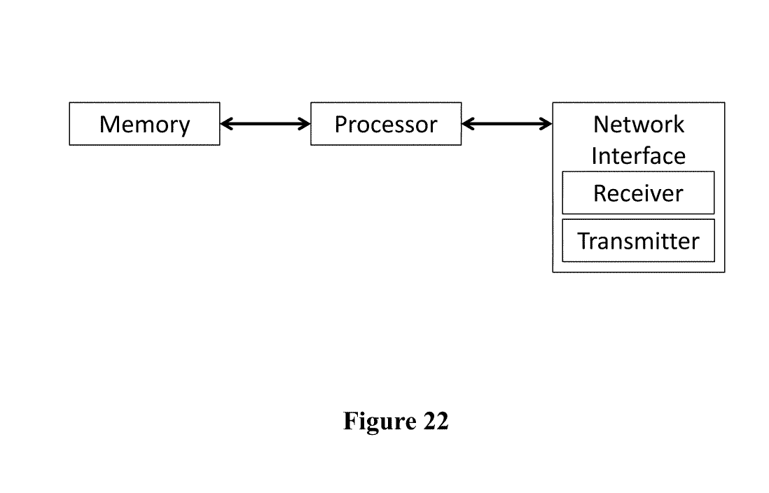

The IPA management system of various embodiments is formed of one or more computing systems. These computing devices may have similar functional features. For example, each of the resource computing devices, central system computing device, and user computing devices of FIG. 21 may have similar functional features. A functional diagram of one embodiment of a suitable computing system is provided in FIG. 22. Although illustrated separately, it is to be appreciated that the various functional blocks of the computing system need not be separate structural elements. For example, in various embodiments, the computing system includes, at least, a processor in data communication with a memory and a network interface, and these components may be embodied in a single chip or two or more chips.

The processor may be a general purpose microprocessor, a digital signal processor (DSP), a field programmable gate array (FPGA), an application specific integrated circuit (ASIC), or other programmable logic device, or other discrete computer-executable components designed to perform the functions described herein. The processor may also be formed of a combination of computing devices, for example, a DSP and a microprocessor, a plurality of microprocessors, one or more microprocessors in conjunction with a DSP core, or any other suitable configuration.

In various embodiments, the processor is coupled, via one or more buses, to the memory in order to read information from and write information to the memory. The processor may additionally or alternatively contain memory. The memory can include, for example, processor cache. The memory may be any suitable computer-readable medium that stores computer-readable instructions for execution by computer-executable components. For example, the computer-readable instructions may be stored on one or a combination of RAM, ROM, flash memory, EEPROM, optical device (e.g., CD or DVD), hard drive, floppy drive, or any suitable device. In various embodiments, the computer-readable instructions include software stored in a non-transitory format.

The processor, in conjunction with the software stored in the memory, executes an operating system and stored software applications. The various methods described elsewhere herein are programmed as software instructions stored in the memory. In some embodiments, the memory may include software for operating the IPA management system as a web server. In some embodiments, the memory includes an internet-accessible database accessible via the network interface.

The network interface of various embodiments includes a receiver and a transmitter for bi-directional communication. The transmitter prepares data according to one or more network standards and transmits data over a communication network. The receiver receives and demodulates data received over a communication network. In some embodiments, a transceiver acts as both a receiver and a transmitter.

The examples and illustrations included herein show, by way of illustration and not of limitation, specific embodiments in which the subject matter may be practiced. Other embodiments may be utilized and derived therefrom, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method of generating an intellectual property portfolio budget performed by an IP management computing device, the method comprising:
receiving a budget request for a future budgetary timeframe from a user via an input device;
receiving an estimate of expected new applications in the future budgetary timeframe from a user via an input device;
automatically identifying a status of each intellectual property asset within an intellectual property portfolio;
automatically determining actions expected within the budgetary timeframe based on the status of each intellectual property asset;
automatically retrieving invoice data for tasks performed within a past budgetary timeframe;
automatically determining expected costs for each expected action and each expected new application based on the invoice data; and
automatically generating an estimated budget comprising the expected costs for the future budgetary timeframe.

2. The method of claim 1, wherein identifying a status of each intellectual property asset within an intellectual property portfolio comprises accessing status data from an internal database.

3. The method of claim 2, wherein the status data is scraped by the IP management computing device from a patent office database.

4. The method of claim 1, wherein the status comprises at least one of a basic prosecution classification, a prosecution history, an assigned examiner, an assigned art unit, and a filing date.

5. The method of claim 1, wherein determining actions expected within the budgetary timeframe comprises accessing historical patent office data, calculating average performance metrics from the historical patent office data, and predicting when actions are to be expected for each intellectual property asset based on the average performance metrics and the status of each intellectual property asset.

6. The method of claim 1, wherein invoice data is retrieved from an internal database.

7. The method of claim 6, wherein the invoice data in the internal database is pulled from an invoice uploaded or imported into the IP management computing device.

8. The method of claim 1, wherein the estimated budget is output by the IP management computing system in a web-based editable format.

9. The method of claim 1, further comprising receiving scenario modifications from a user, wherein the scenario modifications cause the IP management computing device to modify underlying parameters and generate a revised estimated budget.

10. A system for generating an intellectual property portfolio budget, the system comprising:
a computing device comprising a processor and a non-transitory computer-readable medium having instructions stored thereon, wherein the instructions, when executed by the processor, cause the computing device to perform a method comprising:
receiving a budget request for a future budgetary timeframe from a user via an input device;
receiving an estimate of expected new applications in the future budgetary timeframe from a user via an input device;
automatically identifying a status of each intellectual property asset within an intellectual property portfolio;
automatically determining actions expected within the budgetary timeframe based on the status of each intellectual property asset;
automatically retrieving invoice data for tasks performed within a past budgetary timeframe;
automatically determining expected costs for each expected action and each expected new application based on the invoice data; and
automatically generating an estimated budget comprising the expected costs for the future budgetary timeframe.

11. The system of claim 10, wherein identifying a status of each intellectual property asset within an intellectual property portfolio comprises accessing status data from an internal database.

12. The system of claim 11, wherein the status data is scraped by the IP management computing device from a patent office database.

13. The system of claim 10, wherein the status comprises at least one of a basic prosecution classification, a prosecution history, an assigned examiner, an assigned art unit, and a filing date.

14. The system of claim 10, wherein determining actions expected within the budgetary timeframe comprises accessing historical patent office data, calculating average performance metrics from the historical patent office data, and predicting when actions are to be expected for each intellectual property asset based on the average performance metrics and the status of each intellectual property asset.

15. The system of claim 10, wherein invoice data is retrieved from an internal database.

16. The system of claim 15, wherein the invoice data in the internal database is pulled from an invoice uploaded or imported into the IP management computing device.

17. The system of claim 10, wherein the estimated budget is output by the IP management computing system in a web-based editable format.

18. The system of claim 10, further comprising receiving scenario modifications from a user, wherein the scenario modifications cause the IP management computing device to modify underlying parameters and generate a revised estimated budget.

19. A system for generating an intellectual property budget, the system comprising:
a receiver for receiving from a user computing device: a budget request for a future budgetary timeframe, an estimate of expected new applications to be filed in the future budgetary timeframe, and an invoice for a past budgetary timeframe;
a transmitter for transmitting to the user computing device an estimated budget comprising expected costs in the future budgetary timeframe;
a memory configured to store invoice data for tasks performed within the past budgetary timeframe; and
a processor configured to: extract the invoice data from the invoice, identify a status of existing intellectual property assets, determine actions expected within the future budgetary timeframe based on the status of each existing intellectual property asset, determine the expected costs for each expected action and each expected new application based on the invoice data, and generate the estimated budget.

20. The system of claim 19, wherein the receiver is further configured to pull a prosecution status for each intellectual property asset from a remote database.
